(19) United States
(12) Patent Application Publication
(10) Pub. No.: US 2026/0064463 A1
(43) Pub. Date: Mar. 5, 2026

(54) FRAMEWORK TO CONFIGURE AND GENERATE OPERATIONAL DATA SIGNALS FOR CONTROLS

(71) Applicant: ORACLE INTERNATIONAL CORPORATION, Redwood Shores, CA (US)

(72) Inventors: Ramesh RAMAKRISHNAN, Redmond, WA (US); Balaji DUVARAGAMANI, Bengaluru (IN); Gopi Krishna PANDARABOINA, Hyderabad (IN); Kavin Kumar KUPPUSAMY, Fremont, CA (US); Harshavardhan TAKLE, Foster City, CA (US)

(21) Appl. No.: 19/192,735

(22) Filed: Apr. 29, 2025

Related U.S. Application Data
(60) Provisional application No. 63/690,436, filed on Sep. 4, 2024.

(51) Int. Cl. G06F 9/48

(52) U.S. Cl. CPC G06F 9/4881

(57) ABSTRACT

Systems, methods, and other embodiments associated with a framework to configure and generate operational data signals for controls are described. In one embodiment, a method includes accepting input that defines a configuration for a functional sensor in a metadata repository of an enterprise data system. The configuration specifies condition(s) on data source(s) for triggering a signal associated with initiation of a task. The method monitors the data source(s) of the enterprise data system with the functional sensor for transaction changes that satisfy the condition(s) for triggering the signal. The method detects a transaction change that satisfies the condition(s) using the functional sensor. The method emits the signal in response to detection that the condition(s) for triggering the signal are satisfied. And, in response to receiving the signal, the method automatically executes the task in the enterprise data system.

### CROSS REFERENCE TO RELATED APPLICATIONS

This disclosure claims the benefit of U.S. Provisional Patent Application Ser. No. 63/690,436 filed Sep. 4, 2024, titled “FRAMEWORK TO CONFIGURE AND GENERATE OPERATIONAL DATA SIGNALS FOR CONTROLS,” having inventors Ramesh RAMAKRISHNAN, Balaji DUVERGAMANI, Gopi Krishna PANDARABOINA, Harshavardhan TAKLE, Kavin Kumar KUPPUSAMY, and assigned to the present assignee, which is incorporated by reference herein in its entirety.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an functional sensor system, which is associated with a framework to configure and generate operational data signals for controls.

FIG. 2 illustrates one embodiment of an functional sensor method, which is associated with a framework to configure and generate operational data signals for controls.

FIG. 3 illustrates one embodiment of a process flow for the functional sensor system at design time, which is associated with a framework to configure and generate operational data signals for controls.

FIG. 4 illustrates one embodiment of a process flow for the functional sensor system at run time, which is associated with a framework to configure and generate operational data signals for controls.

FIG. 5 illustrates examples for approval sensors and examples for non-approval sensors, which are associated with a framework to configure and generate operational data signals for controls.

FIG. 6 illustrates one embodiment of an functional sensor system showing integration with other frameworks, which is associated with a framework to configure and generate operational data signals for controls

FIG. 7 illustrates one embodiment of an on-boarding flow, which is associated with a framework to configure and generate operational data signals for controls.

FIG. 8 illustrates one embodiment of a runtime execution flow for polling a data source, which is associated with a framework to configure and generate operational data signals for controls.

FIG. 9 illustrates one embodiment of a runtime execution flow for data source Change Data Capture (CDC) events, which is associated with a framework to configure and generate operational data signals for controls.

FIG. 10 illustrates one embodiment of an execution flow for creation and execution of functional sensors, which is associated with a framework to configure and generate operational data signals for controls.

FIG. 11 illustrates one embodiment of a conceptual diagram for an functional sensor system, which is associated with a framework to configure and generate operational data signals for controls.

FIG. 12 illustrates one embodiment of a logical data model diagram for an functional sensor system, which is associated with a framework to configure and generate operational data signals for controls.

FIG. 13 illustrates one embodiment of a sensor entity diagram for an functional sensor system, which is associated with a framework to configure and generate operational data signals for controls.

FIG. 14 illustrates an embodiment of a computing system configured with the example systems and/or methods disclosed.

### DETAILED DESCRIPTION

Systems, methods, and other embodiments are described herein that provide a framework to configure and generate operational data signals for controls. In one embodiment, the framework is implemented as an functional sensor system. The users of an enterprise data system input the conditions and data sources associated with launching a task to create a functional sensor. The functional sensor then monitors data transactions to determine whether to launch the task.

In one embodiment, the functional sensor system improves a modern ERP architecture by enabling a user to categorize enterprise data through configurable tagging and labeling based on digital conditions, such as logical rules that describe business conditions applied by an enterprise customer. The functional sensor system allows enterprise customers to segment their customers and suppliers based on their business transactions. The functional sensor system also allows customers to configure digital audit policies, digital period close checks, and other digital control checks. These checks can trigger actions such as user notifications or automated responses to specific events. The configurations for these checks are driven by user definition. The configurations are translated into implicit policies and rules by the functional sensor system that are executed natively within the enterprise data system, ensuring seamless and automated management of business processes.

In one embodiment, an functional sensor method includes accepting input that defines a configuration for a functional sensor in a metadata repository of an enterprise data system. The configuration specifies condition(s) on data source(s) for triggering a signal associated with initiation of a task. The functional sensor method monitors the data source(s) of the enterprise data system with the functional sensor for transaction changes that satisfy the condition(s) for triggering the signal. The functional sensor method detects a transaction change that satisfies the condition(s) using the functional sensor. The functional sensor method emits the signal in response to detection that the condition(s) for triggering the signal are satisfied. And, in response to receiving the signal, the functional sensor method automatically executes the task in the enterprise data system. The functional sensor method may be executed by an functional sensor system, for example as described herein.

In one example, the functional sensor framework supports monitoring of data source, based on, e.g., predefined schedules, change data capture events, or internal events generated by an enterprise data application. If the functional sensor is registered based on a given type of data source, the functional sensor framework will be triggered and start the monitoring processing when the data source of the given type is active.

### Definitions

As used herein, the term “enterprise data system” refers to computerized data systems used by an enterprise to manage operations, analytics, and/or compliance. Enterprise data systems include, but are not limited to: ERP (Enterprise Resource Planning) systems, CRM (Customer Relationship Management) systems, and HR (Human Resources/Human Capital Management) systems, Financial Planning and Analysis (FP&A) systems, General Ledger (GL) systems, Accounts Payable (AP)/Accounts Receivable (AR) systems, Expense Management systems, Tax Management systems, Supply Chain Management (SCM) systems, Warehouse Management Systems (WMS), Inventory Management systems, Transportation Management Systems (TMS), Manufacturing Execution Systems (MES), Product Lifecycle Management (PLM) systems, Business Intelligence (BI) Tools, Master Data Management (MDM) systems, Customer Data Platforms (CDP), Product Information Management (PIM) systems, Digital Experience Platforms (DXP), Marketing Automation Platforms, Content Management Systems (CMS), Governance, Risk, & Compliance (GRC) systems, IT Infrastructure & Service Management systems, and Contract Lifecycle Management (CLM) systems.

As used herein, the term “functional sensor” refers to sensors implemented by functions or computer logic. For example, a functional sensor can be configured to monitor a specific behavior, condition, or performance indicator of an enterprise data system by evaluating operational data of the enterprise data system according to defined rules or logic.

No action or function described or claimed herein is performed by the human mind. An interpretation that any action or function can be performed in the human mind is inconsistent with and contrary to this disclosure.

### —Example ERP Sensor System—

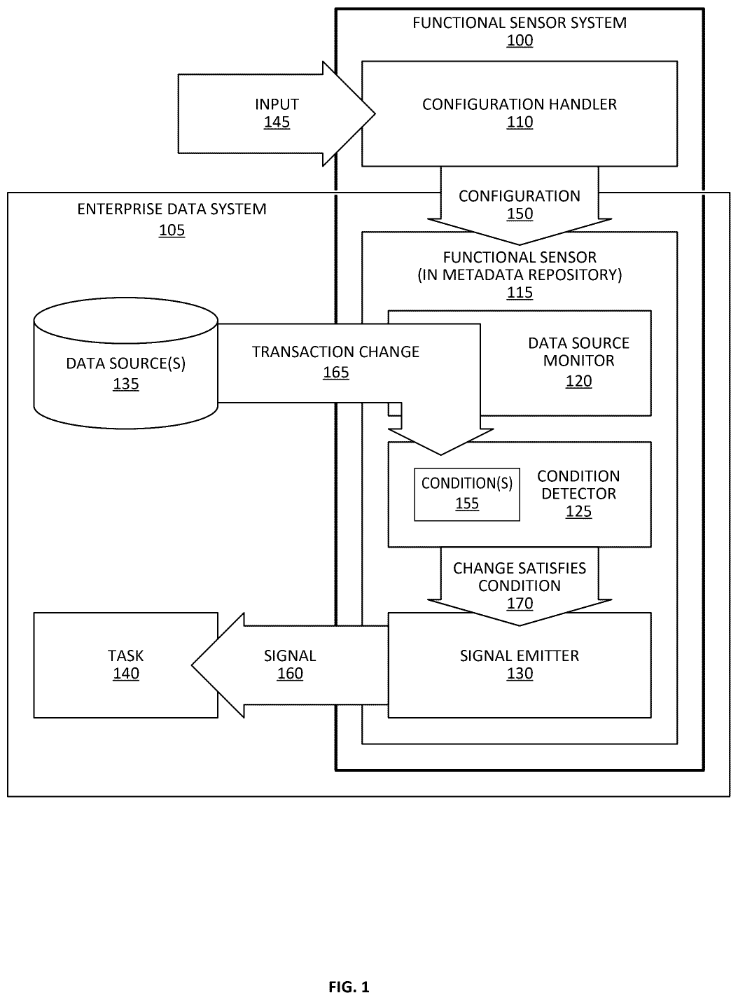

FIG. 1 illustrates one embodiment of a functional sensor system 100 that is associated with a framework to configure and generate operational data signals for controls. In one embodiment, functional sensor system 100 operates to create functional sensors and set them to monitoring transaction changes occurring within an enterprise data system. Where a sensed transaction change satisfies a condition, the functional sensor system 100 signals that the enterprise data system should perform a task associated with the condition. enterprise data system 100 may be configured to cooperate with an enterprise data system 105, for example as components of enterprise data system 105 or as an add-on to enterprise data system 105. functional sensor system 100 has various components, including a configuration handler 110, and a functional sensor 115. The functional sensor 115 includes a data source monitor 120, a condition detector 125, and a signal emitter 130. enterprise data system 105 includes one or more data sources 135, and one or more executable tasks 140. In one embodiment, the components of functional sensor system 100 and enterprise data system 105 intercommunicate in a network computing system, for example by electronic messages, as discussed below under the heading “Cloud or Enterprise Embodiments.”

In one embodiment, configuration handler 110 is configured to accept input 145 that defines a configuration 150 for a functional sensor 115 in a metadata repository of an enterprise data system 105. The configuration 150 specifies one or more conditions 155 applied to one or more data sources 135 for triggering a signal 160 associated with initiation of a task 140. In one embodiment, data source monitor 120 of the functional sensor 115 is configured to monitor the one or more data sources 135 of the enterprise data system 105 with the functional sensor 115 for transaction changes 165 that satisfy the one or more conditions 155 for triggering the signal 160. In one embodiment, condition detector 125 of the functional sensor 115 is configured to detect a transaction change 165 that satisfies 170 the one or more conditions 155 with the functional sensor 115. In one embodiment, signal emitter 130 is configured to emit the signal 160 in response to detection that the one or more conditions 155 for triggering the signal are satisfied 170. In one embodiment, enterprise data system 105 is configured by functional sensor system 100 to, in response to receiving the signal 160, automatically execute the task 140 in the enterprise data system 105.

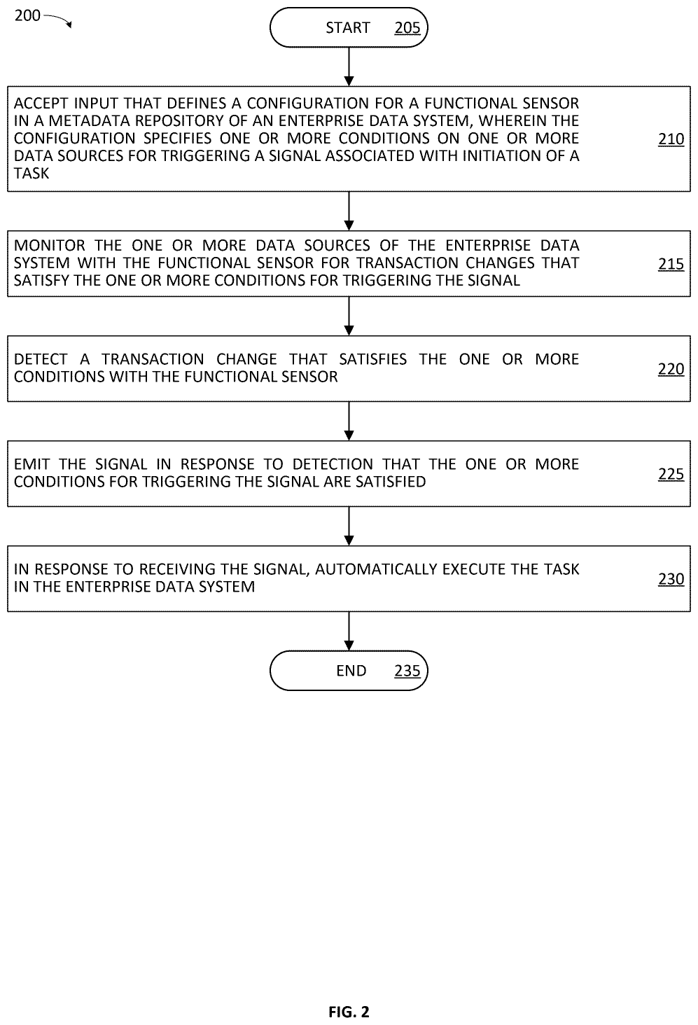

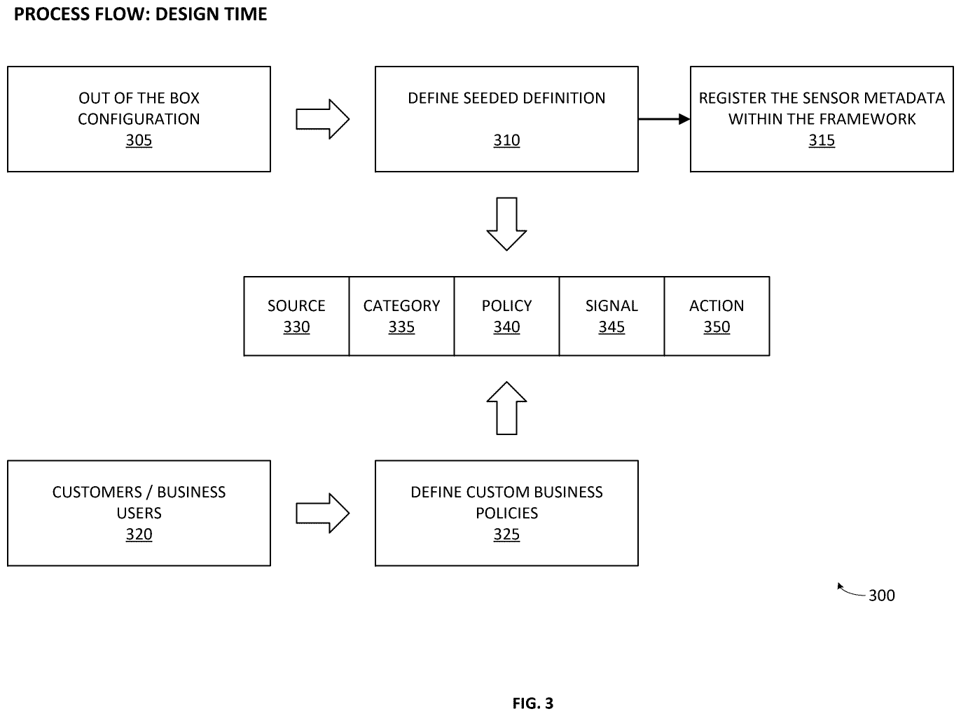

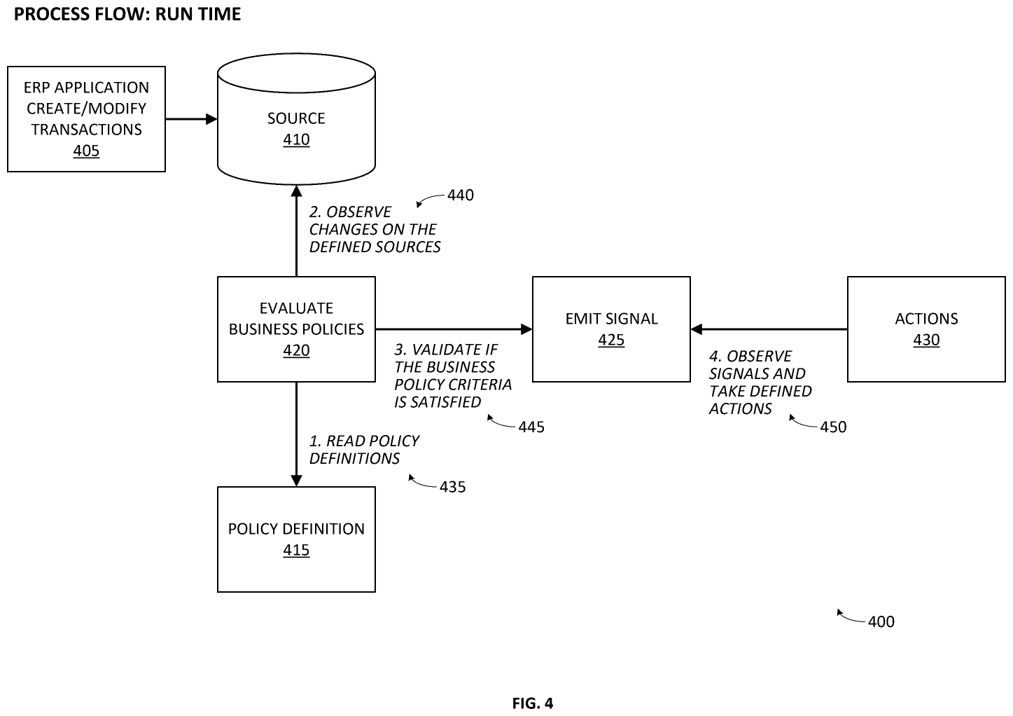

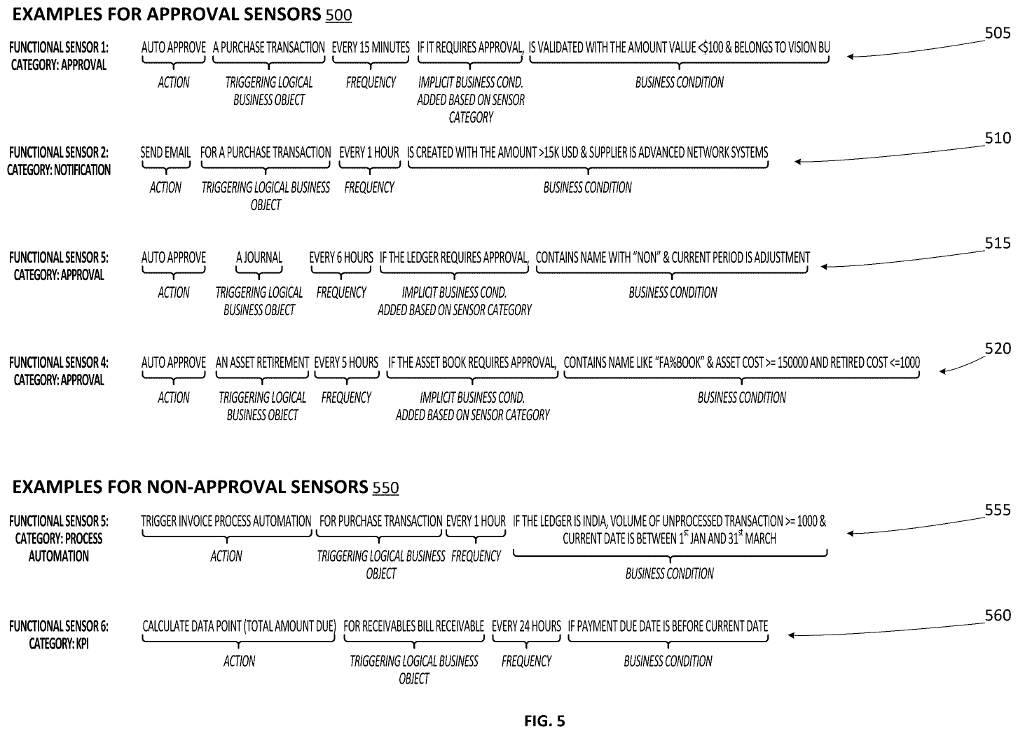

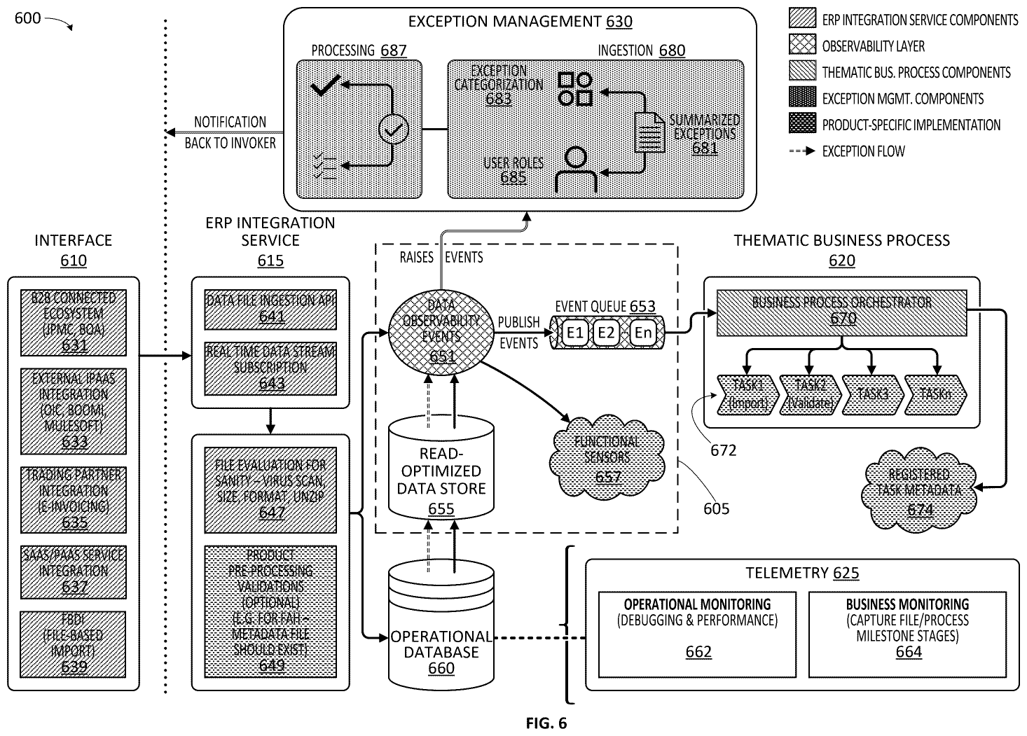

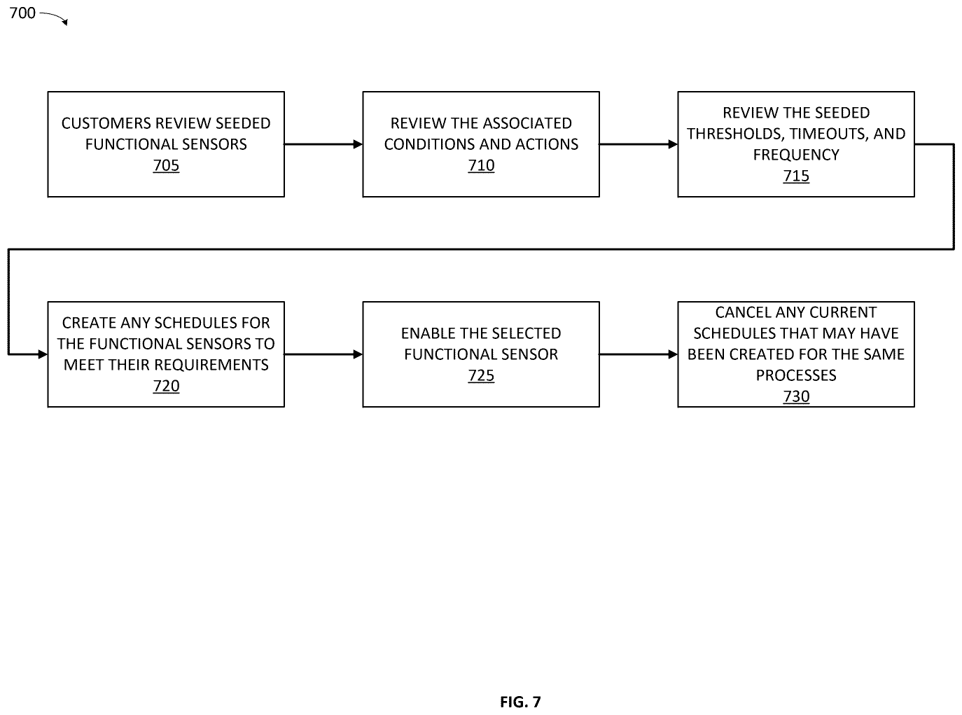

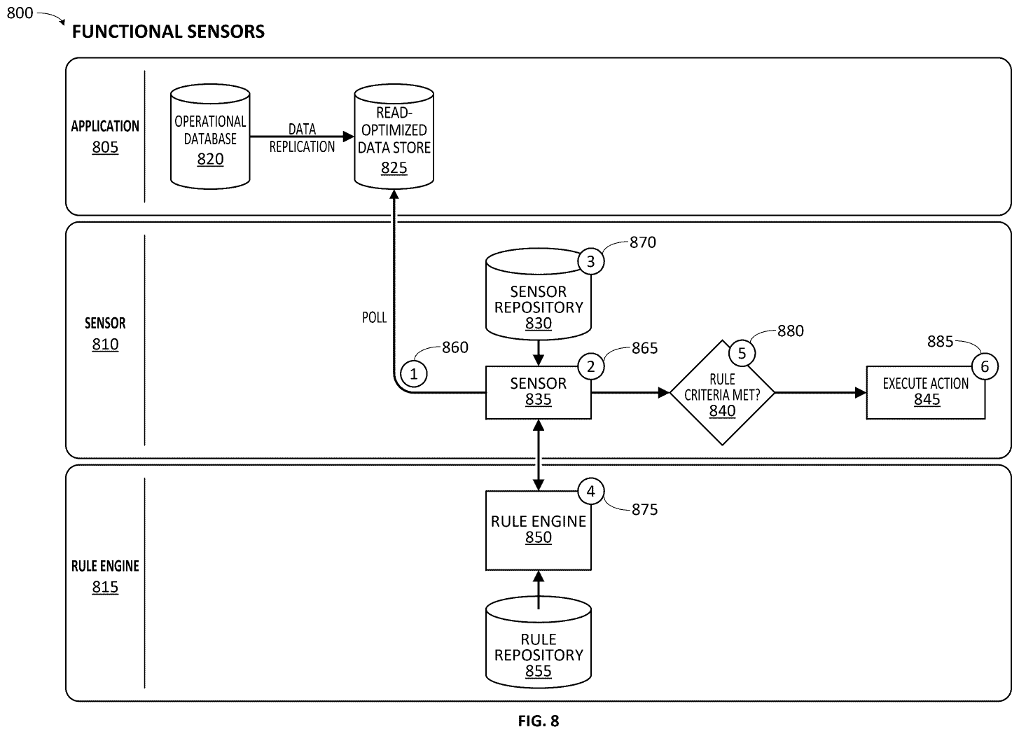

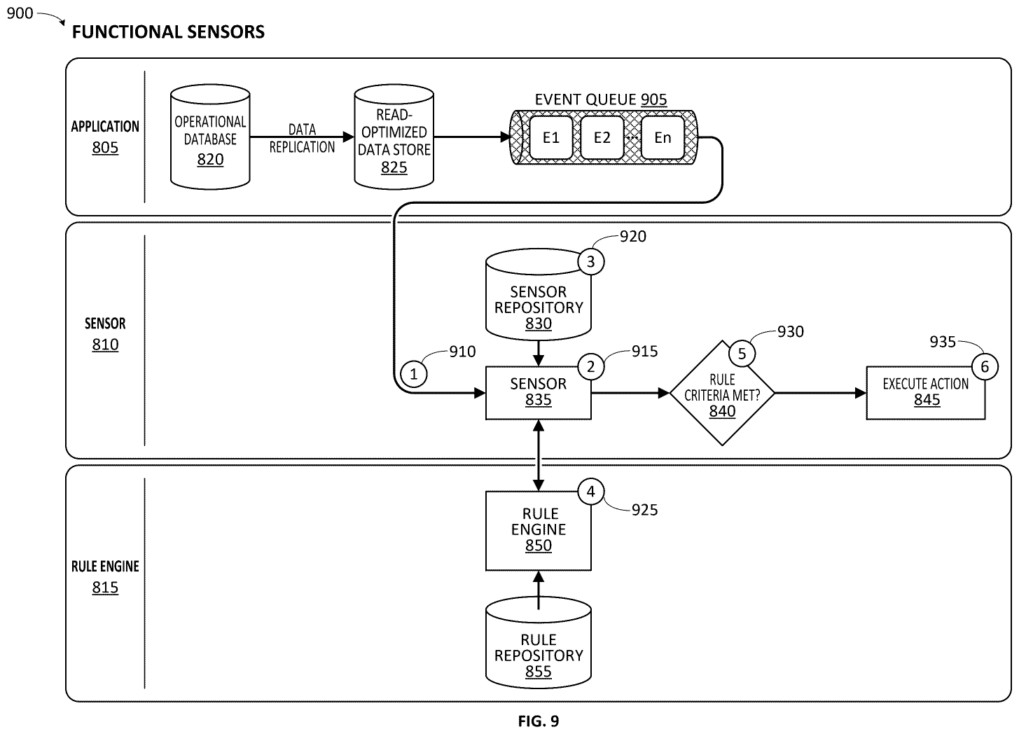

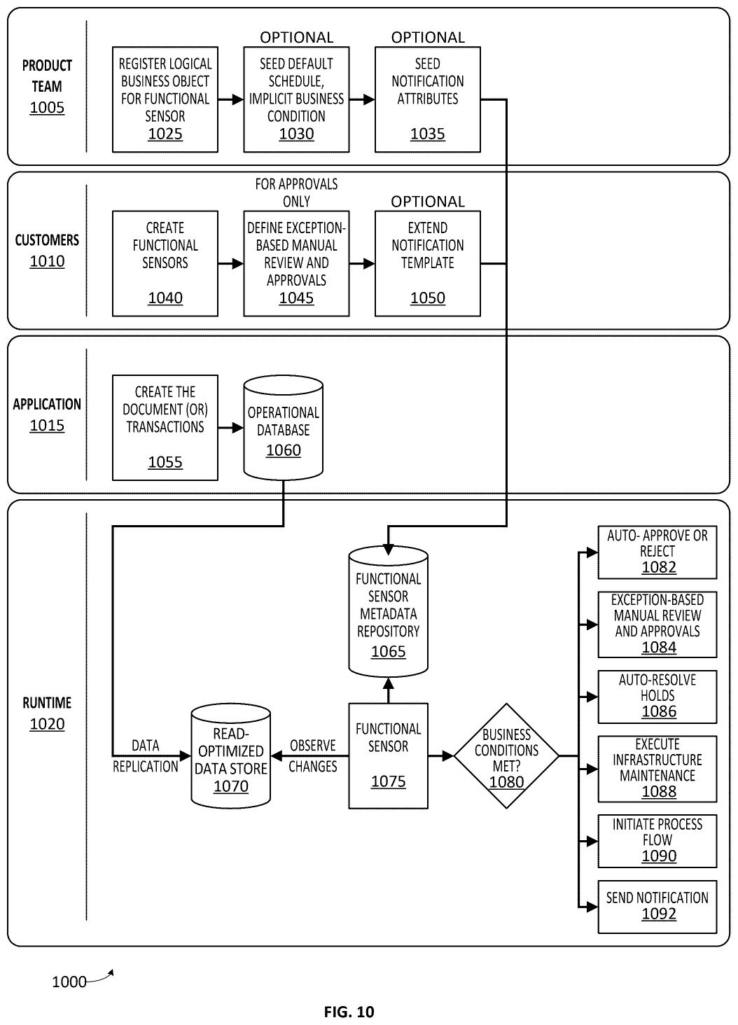

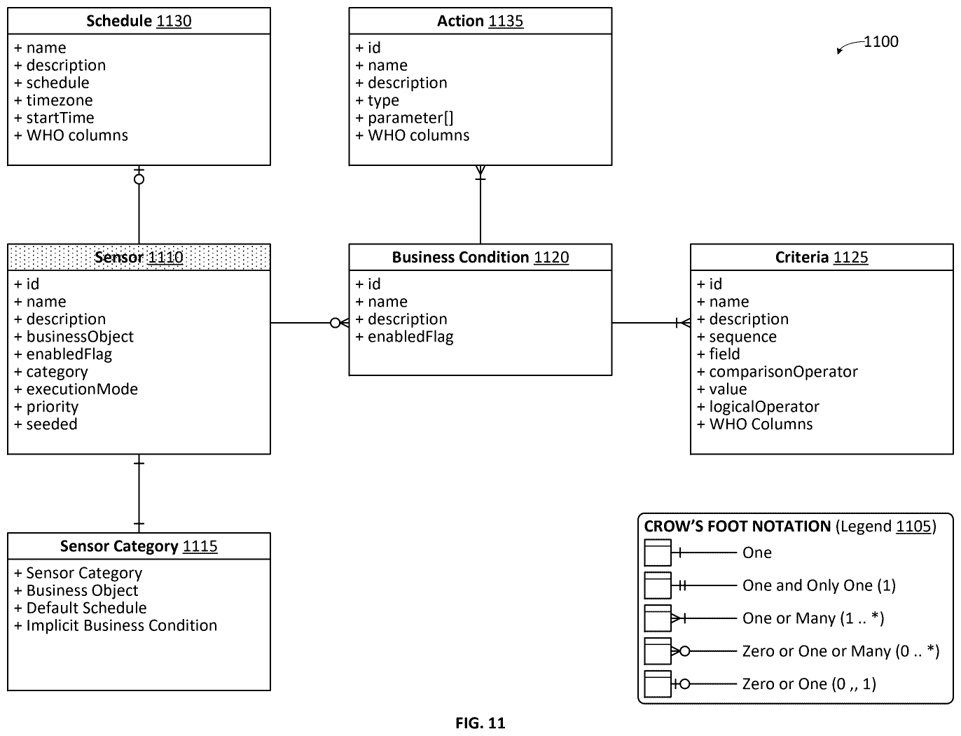

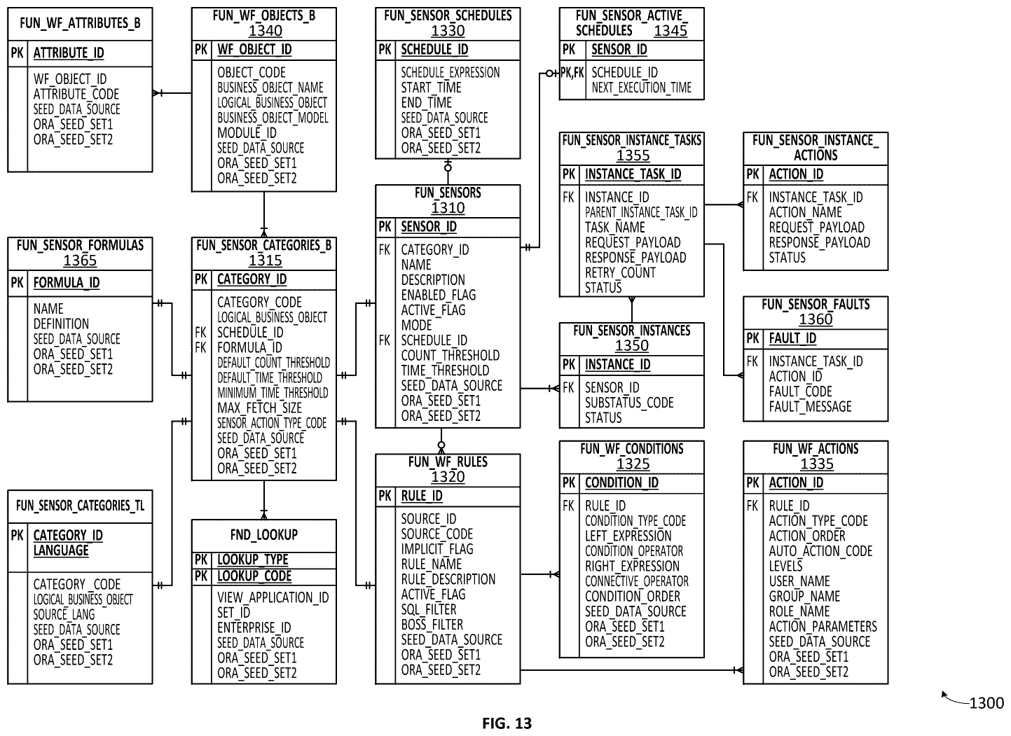

Further details regarding functional sensor system 100 are presented herein. Example operations of functional sensor system 100 will be described with reference to functional sensor method 200 of FIG. 2. Example design time operations of functional sensor system 100 will be described with reference to process flow 300 of FIG. 3. Example run time operations of functional sensor system 100 will be described with reference to process flow 400 of FIG. 4. Examples of functional sensors will be described with reference to examples for approval sensors 500 and examples for non-approval sensors 550 of FIG. 5. An example on-boarding flow 600 for functional sensor system 100 will be described with reference to FIG. 6. An example of polling a data source by the functional sensor system 100 to obtain transaction changes will be described with reference to FIG. 7. An example of using change data capture (CDC) by the functional sensor system 100 to obtain transaction changes will be described with reference to FIG. 8. An example runtime execution flow 900 for functional sensor system 100 will be described with reference to FIG. 9. An example execution flow 1000 for creation and execution of functional sensors in the functional sensor system will be described with reference to FIG. 10. An overview of the logical structure of functional sensor system 100 will be described with reference to conceptual diagram 1100 of FIG. 11. An example logical structure for functional sensor system 100 will be described with reference to logical data model diagram 1200. Example entities used to implement functional sensor system 100 will be described with reference to sensor entity diagram 1300 of FIG. 13.

### —Example ERP Sensor Method—

FIG. 2 illustrates one embodiment of a functional sensor method 200 that is associated with a framework to configure and generate operational data signals for controls. In one embodiment, as a general overview, functional sensor method 200 receives a configuration for a functional sensor. The configuration states conditions under which an action should be triggered, and stipulates data source(s) to monitor for transactions that change data in a way that satisfies the conditions. The functional sensor method 200 sets up the configuration of the functional sensor in metadata of an enterprise data system. The functional sensor method 200 uses the configured functional sensor to observe the transactions, detect when the transactions satisfy the conditions for triggering the action, and, in response to the detection, signals that the action should be performed. The enterprise data system then performs the action.

In one embodiment, functional sensor method 200 initiates at START block 205 in response to functional sensor system 100 determining that one or more conditions or events have been detected or have occurred. The conditions or events for initiating functional sensor method 200, include, but are not limited to: (1) functional sensor system 100 has received an instruction to create or configure a functional sensor; (2) functional sensor system 100 has received an instruction to monitor an enterprise data system with a functional sensor; (3) a user or administrator has initiated functional sensor method 200; (4) it is currently a time at which functional sensor method 200 is scheduled to be run; or (5) some other condition for commencing functional sensor method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of functional sensor system 100 executes functional sensor method 200. In one embodiment, at START block 205, functional sensor system 100 configures compute resources for performing functional sensor method 200. (1) functional sensor system 100 provisions (i.e., allocates and initializes) resources of the computing system that are used by functional sensor system 100, such as processor, memory and storage (for example, for executing components of functional sensor system 100). (2) functional sensor system 100 establishes access to one or more networks for the resources, such as access to (a) internal networks for communication among components of functional sensor system 100 and (b) external networks for communication with other computing systems (for example, client systems or enterprise data system 105). (3) functional sensor system 100 connects to data sources (such as databases, data stores, file systems, and cloud storage) used by the functional sensor method 200. And, (4) functional sensor system 100 configures the computing system with system settings, software dependencies and libraries, and modules for executing the components of functional sensor system 100. Following initiation at START block 205, functional sensor method 200 proceeds to block 210.

At block 210, functional sensor method 200 accepts input that defines a configuration for a functional sensor in a metadata repository of an enterprise data system. The configuration specifies one or more conditions applied to one or more data sources for triggering a signal associated with initiation of a task. Thus, functional sensor method obtains information to populate parameters of a sensor that is implemented in logic, and records them in the metadata repository. functional sensor method 200 thus accesses the configuration.

The metadata repository of the enterprise data system is a configuration store, registry, or catalog that is configured to store definitions, customizations, and other metadata about the how to process and interpret data entities in the enterprise data system. (This is in contrast to the data entities in the ERP themselves). Upon creation, functional sensors may be registered in the metadata repository for execution by the enterprise data system.

The configuration definition for a functional sensor may include several parts. The configuration definition may include a designated action to be initiated in response to activation (i.e. satisfaction of the conditions) of the functional sensor. The configuration definition may include a type of business object that the functional sensor monitors, and/or that the action operates on. The configuration definition may include a frequency of operation for the functional sensor. The configuration definition may include a definition of the rule or condition under which the functional sensor activates, and triggers the associated action. Examples of the content of configuration definitions are shown in and described with reference to FIG. 5, below.

The configuration definition may also include an implicit business condition that is automatically included based on a category to which the functional sensor belongs. Categories or types of functional sensors include, but are not limited to approval, notification, process automation, and key performance indicator (KPI) sensors.

In one embodiment, a functional sensor is created from a template by populating variables with the values that are provided by the input. The input specifies: (1) data sources within the enterprise data system to be monitored, and (2) conditions for triggering an electronic signal or instruction. The conditions are configured to evaluate to “true” (trigger the signal) or “false” (do not trigger the signal) based on values obtained from the data sources. Also, the input may specify a task or other action that is to be performed upon satisfaction of the condition. Specification of the task may be performed by indication in the input of a signal category to be emitted by the sensor. In one embodiment, a template functional sensor that corresponds to the indicated signal type is loaded, and populated with the values from the input for data sources and conditions to produce the functional sensor. Once created, the functional sensor is stored for subsequent execution by the enterprise data system, and registered in the metadata repository.

In one embodiment, the input is a pre-defined configuration or definition for a functional sensor. Thus, one embodiment, the functional sensor method 200 gets a data structure (such as a file or database record) that contains the pre-defined configuration. The pre-defined configuration may be an initial configuration for a sensor which may be subsequently adjusted by user input. Thus, this initial, out-of-the-box pre-defined configuration may also be referred to as a “seeded” configuration or definition.

In one embodiment, the input is user input entered, e.g., through a user interface, that specifies the configuration for a functional sensor. The user input may re-configure an existing, previously configured functional sensor to have an adjusted configuration. Or, the user input may specify a configuration of a new, custom, functional sensor.

The input may specify a wide variety of tasks that may be triggered. For example, the input may configure a functional sensor: (i) to monitor a data source of invoice data, (ii) to apply condition(s) under which an invoice exception is applicable to the invoice data, and (iii) to configure the functional sensor to signal that the invoice exception is to be applied in response to satisfaction of the condition. In another example, the input may configure a functional sensor: (i) to monitor a data source of invoice data, (ii) to apply condition(s) under which an invoice is to be placed on hold to the invoice data, and (iii) to configure the functional sensor to signal that an invoice is to be placed on hold in response to satisfaction of the condition. In another example, the input may configure a functional sensor: (i) to monitor a data source of accounts receivable data, (ii) to apply condition(s) (e.g., delinquent amount, receivables balance) under which an account is to be placed into a particular category, and (iii) to configure the functional sensor to signal that an account is to be placed into a specified category upon satisfaction of the condition. Other examples appear elsewhere herein, for example under the heading “Example Use Cases” below.

In one embodiment, functional sensor method 200 accepts input that defines a configuration for a functional sensor in a metadata repository of an enterprise data system by: (i) accessing a particular data structure that includes the input from a specified location in storage or listening, at an API endpoint, for the input through a user interface; (ii) selecting a template functional sensor or a pre-existing functional sensor that is indicated by the input and populating variables of the functional sensor with values for the data source(s) and trigger condition(s) with values provided in the input; and (iii) registering the populated functional sensor into the metadata repository of the enterprise data system for execution by the ERP.

In one embodiment, the steps of block 210 are performed by configuration handler 110. At the conclusion of block 210, functional sensor method 200 has created a functional sensor in the metadata repository that operates as specified by the input. At runtime, when the functional sensor is operated, the functional sensor method reads a definition of the configuration for the functional sensor from storage, and configures the functional sensor to operate accordingly. Additional detail regarding the initial configuration of the functional sensor are discussed below with reference to FIG. 3. Processing continues to block 215.

At block 215, functional sensor method 200 monitors the one or more data sources of the enterprise data system with the functional sensor for transaction changes that satisfy the one or more conditions for triggering the signal. functional sensor method applies the defined functional sensor to relevant ERP data sources, detecting transaction activity that fulfills the specified trigger criteria for sending the signal. The functional sensor method 200 observes transaction changes that are occurring on the data sources specified in the configuration definition.

For example, the functional sensor method 200 may continually—i.e., repeatedly, at a specified frequency-check the designated data sources for updates to transactions that match the conditions. Thus, the execution mode of the functional sensor may be scheduled at time intervals. The frequency of checks may be high enough to provide information without substantial delay at the scale of human perception, thereby providing for practically real-time sensing of transaction changes. Or, the frequency may be lower, for example for batch processing. Or, in another example, the execution mode of the functional sensor may be event-driven, in which checks for updates occur in response to notification of a data change.

In one embodiment, the functional sensor method 200 gathers transaction changes directly from a live operational database in which transactions are being processed. In one embodiment, the functional sensor method gathers transactions from a read-optimized data store to which completed transactions are transferred from the live operational database. As used herein with respect to moving data from an operational database to a read-optimized data store, the terms “transfer” or “transferred” may refer to a variety of techniques for duplicating data, including, but not limited to: (1) replication-using, e.g., transaction log shipping, change streams, or binary log mirroring to create real-time or near-real-time copies of one or more portions of the operational database in the read-optimized data store; (2) ETL (Extract, Transform, Load)—periodically extracting data from the operational database, transforming the data it (if needed), and load the data into the read-optimized data store; (3) Export or Dump-periodically generating a full or partial snapshot of the operational database in the read-optimized data store; and (4) Change Data Capture-tracking and exporting incremental changes (insert/update/delete) from the operational database to the read-optimized data store.

In one embodiment, the read-optimized data store is a near-real-time read-only transaction (e.g., financial activity (FA)) data source for clients. Use of the read-optimized data store prevents the occurrence of an infrastructure bottleneck due to using the live transaction database for both performing transactions and reads for the functional sensor system. In one embodiment, the read-optimized data store is internal to the functional sensor system, and is not available to consumers external to the functional sensor system. use of the read-optimized data store removes the burden of managing the data pipeline and transformation infrastructure from the sensor dataflow, and prevents the functional sensor system from placing additional load on the live transaction database. Use of the read-optimized data store allows the functional sensor method 200 to gather transaction changes from data at rest.

functional sensor method 200 gathers transaction changes, collecting records from the one or more ERP data sources that have been updated since a previous check. In one embodiment, functional sensor method 200 polls the ERP data sources to retrieve the transaction changes that have occurred since an immediately prior polling (for example as shown and described below with reference to FIG. 8). In one embodiment, the functional sensor method 200 dequeues, from an event queue of transaction changes, a set of transaction changes that had been enqueued since an immediately prior dequeuing (for example as shown and described below with reference to FIG. 9). In one embodiment, the functional sensor method gathers the transaction changes by subscribing to and receiving CDC events.

The gathered transaction changes are made available for subsequent comparison against the defined conditions of the functional sensor. For example functional sensor method 200 may parse the transaction changes to extract data values from that are used in the condition, and populate the variables of the condition with the corresponding extracted values. For example, the variables may be associated with values in a data structure that may be made available downstream to the condition detector, such as by transmission of an electronic message including the data structure to the condition detector, or by writing the values into a data structure that is accessible to the condition detector.

In one embodiment, functional sensor method 200 monitor the one or more data sources of the enterprise data system with the functional sensor for transaction changes that satisfy the one or more conditions for triggering the signal by: (i) establishing or maintaining a connection to the ERP data sources; and (ii) gathering recent transaction changes from the ERP data sources.

In one embodiment, the steps of block 215 are performed by data source monitor 120. At the conclusion of block 215, functional sensor method 200 has collected records of transaction changes that are relevant to condition evaluation by the functional sensor. For example, functional sensor method has obtained current runtime values for the variables of the condition that will be evaluated at block 220. Processing continues to block 220.

At block 220, functional sensor method 200 detects a transaction change that satisfies the one or more conditions with the functional sensor. The functional sensor method evaluates the rules of the functional sensor on the gathered transaction data to determine whether the transaction changes satisfy a threshold for triggering a signal. functional sensor method 200 validates whether the criteria of the functional sensor is satisfied by the data values observed in the transaction changes.

In one embodiment, functional sensor method 200 detects a transaction change that satisfies the one or more conditions with the functional sensor by: (i) accessing the rule definitions for the functional sensor, including logical operators and threshold values; (ii) loading (or otherwise accessing) transaction changes that were flagged and/or retrieved in the previous monitoring step; (iii) comparing the transaction changes against the conditions (as described by the rule definitions) of the functional sensor; (iv) evaluating the logical outcome of the comparison, thereby determining whether the aggregate result for each transaction change satisfies the criteria of the functional sensor (true) or not (false); (v) flagging the those transaction changes that satisfy the criteria; and (vi) recording the detection result for subsequent processing, for example by creating or updating a record noting that the functional sensor has discovered one or more matching transaction changes.

In one embodiment, the steps of block 220 are performed by condition detector 125. At the conclusion of block 220, functional sensor method 200 has detected activity in ERP transactions that satisfy the rule or policy that the functional sensor is configured to detect. Processing continues to block 225.

At block 225, functional sensor method 200 emits the signal in response to detection that the one or more conditions for triggering the signal are satisfied. The functional sensor generates a signal upon confirmation that the conditions are satisfied by a monitored transaction change. In other words, the functional sensor transmits a signal when it detects that threshold(s) specified by the rule definition have been reached.

The signal may be an electronic message. The signal is configured to deliver to the enterprise data system a payload that includes information about the transaction change and the functional sensor. The signal may include and identifier (ID) for the functional sensor. The signal may include identification (ID) of the particular monitored transaction change(s) that caused the conditions of the functional sensor to be satisfied. The signal may include a timestamp associated with the detection, for example a time stamp at which the particular monitored transaction change(s) occurred.

In one embodiment, functional sensor method 200 emits the signal in response to detection that the one or more conditions for triggering the signal are satisfied by: (i) accessing the status of condition evaluation (as set by the previous detection step), for example by checking a flag or result to see if the conditions have been satisfied; (ii) creating and packaging the signal payload, for example by assembling relevant information such as ID of the functional sensor, timestamp of the condition-satisfying transaction change, and ID of the condition-satisfying transaction change; (iii) assigning a process, queue, or other component of the enterprise data system to be the destination or recipient of the signal; and (iv) publishing or sending the signal event, for example by writing the signal to a message queue or invoking an API call to notify the designated destination or recipient.

In one embodiment, the steps of block 225 are performed by signal emitter 130. At the conclusion of block 225, functional sensor method 200 has informed the enterprise data system that the functional sensor has detected an occurrence of a particular activity that the functional sensor was set up to catch. Processing continues to block 230.

At block 230, functional sensor method 200 in response to receiving the signal, automatically execute the task in the enterprise data system. In one embodiment, the functional sensor method 230 observes the signal, and takes a pre-defined action in response to the signal. Thus, upon receiving the emitted signal, the functional sensor method initiates and runs (in the enterprise data system) a task that is associated with receiving the particular signal from the functional sensor.

In one embodiment, functional sensor method 200 in response to receiving the signal, automatically execute the task in the enterprise data system by: (i) parsing the signal to extract details of the signal (e.g., functional sensor ID, timestamp, relevant transaction change); (ii) determining the task(s) that corresponds the signal details; (iii) accessing information (such as an associated API call) for initiating the task; (iv) initializing or scheduling the task execution; and (v) execute the task and record the outcome.

In one embodiment, the steps of block 230 are performed by enterprise data system 105. At the conclusion of block 230, functional sensor method 200 has executed a pre-determined task in response to a detection by the functional sensor of the conditions under which the task is to occur. Processing continues to END block 235, where functional sensor method 200 concludes. Note that functional sensor method 200 may enter a loop of runtime operations of blocks 215, 220, 225, and 230. The loop may repeat from block 215 at the designated frequency for the functional sensor.

### —Example Additional Features of ERP Sensor Method—

In one embodiment, functional sensor method 200 registers the configured functional sensor in a metadata repository of the enterprise data system to cause the enterprise data system to execute the functional sensor at runtime. This registration includes defining the inputs, outputs, and conditions of the functional sensor and persisting the configuration in the metadata repository so that the enterprise data system will recognize and invoke the functional sensor at runtime. Registration precedes the monitoring step of block 215. The configuration and registration of the functional sensors gives the user the ability to configure new monitoring, alerting, and actioning processes in the enterprise data system while it is live, without waiting for new releases and deployments of the enterprise data system. This improves over prior systems, in which modifications were hard-coded into new releases.

In one embodiment, the functional sensor is assigned to a category by the input. The category of the functional sensor dictates the type of task (action) that is triggered by the functional sensor. Accordingly, in one embodiment, functional sensor method 200 defines the functional sensor as belonging to one of a plurality of types of categories. (a) The assigned category may be an approval category for which the signal from the functional sensor triggers approving a transaction as the task. (b) The assigned category may be a key performance indicator (KPI) category for which the signal from the functional sensor triggers generating a data value for performance with respect to a goal as the task. (c) The assigned category may be a notification category for which the signal from the functional sensor triggers notifying a system or user of information as the task. (d) The assigned category may be a process automation category for which the signal from the functional sensor triggers initiating a process automation flow as the task. (e) The assigned category may be an enrichment category for which the signal from the functional sensor triggers data enrichment as the task. (f) The assigned category may be a holds category for which the signal from the functional sensor triggers placement or release of a hold as the task. (g) The assigned category may be an audit category for which the signal from the functional sensor triggers an audit process as the task. Or, (h) the assigned category may be an infrastructure category for which the signal from the functional sensor triggers infrastructure management as the task.

In one embodiment, the input includes a frequency or period at which the functional sensor is to repeat its process of monitoring of transaction changes persisted in the read-optimized data store to detect and notify the enterprise data system about transaction changes that satisfy the sensor conditions. For example, at block 210, functional sensor method 200 also accepts a frequency in the input. functional sensor method 200 then configures the functional sensor to repeatedly execute at runtime at the frequency. functional sensor method 200 then repeats its monitoring of the one or more data sources, detecting of the transaction change, and emitting of the signal at the frequency.

In one embodiment, the functional sensor may be scheduled to monitor the transaction changes to detect and notify the enterprise data system about those transaction changes that satisfy the sensor conditions in advance of or following some occasion (such as close of a fiscal year). In other words, the functional sensor is scheduled to execute at date and time (or, simply “time”) that is relative to the time of the occasion. For example, this relative time might be 3 days before the occasion of close of the fiscal year (close-3). The system looks up the actual time of the occasion, and determines from that occasion time and the relative time a non-relative, actual time to execute the functional sensor. Thus, in one embodiment, functional sensor method 200 accepts a relative time away from an occasion in the input. functional sensor method 200 then determines an occasion time at which the occasion will occur. functional sensor method 200 determines a non-relative time based on the occasion time and the relative time. And, functional sensor method executes the functional sensor at the non-relative time.

In one embodiment, execution of the functional sensor is event-driven, occurring on an on-demand basis as soon as the data changes. The functional sensor waits for a transaction change that is of a type that the functional sensor is configured to monitor, and execute on that transaction change in response to its occurrence. Therefore, in one embodiment, functional sensor method 200 executes the functional sensor at runtime in response to receipt of the transaction change.

In one embodiment, the input to define the configuration of the functional sensor is provided in natural language. As used herein, “natural language” refers to natural, everyday language used by people to communicate, including written text or spoken dictation that is used to express the configuration of the functional sensor. The functional sensor method 200 therefore further performs natural language processing on the input to extract the conditions, (and in one embodiment, one or more of the source, category, policy, signal, and action as well). Thus, in one embodiment where the input that defines a configuration is provided in natural language, the functional sensor method 200 converts the natural language into the one or more conditions.

Referring briefly to FIG. 5 below, the configurations of the functional sensors are expressed in natural language. For example, functional sensor 6 560 is expressed as “Calculate data point (total amount due) for receivables bill receivable every 24 hours if payment due date is before current date.” This natural language is parsed to extract the action, the source object, the frequency, and the policy (or business condition).

In one embodiment, the functional sensor method 200 converts the natural language into the one or more conditions, action, source object, and frequency by: (i) parsing the text (tokenize and apply natural language processing techniques) to identify key phrases; (ii) classifying or labeling the extracted phrases as condition, action, source object, or frequency; (iii) mapping these labeled items to the corresponding fields of the functional sensor; and (iv) storing the structured output (condition, action, source object, frequency) in the sensor metadata definition.

### —Example Use Cases—

In one embodiment, the functional sensor system provides the ability to automatically assign invoice exceptions to users based on configurable business policies.

In one embodiment, the functional sensor system provides the ability to define policies that automatically place an invoice on hold until the underlying exception is resolved and automatically prevent the invoice from getting processed further along the life cycle of the invoice.

In one embodiment, the functional sensor system provides the ability to automatically categorize customers based on various dimensions like Delinquent Amount, Receivables Balance, etc. for strategizing collection and cash forecasting.

In one embodiment, the functional sensor system provides the ability to automatically identify top suppliers based on the payables amount for predictive cash forecasting.

In one embodiment, the functional sensor system provides the ability to configure policies that automatically assign receivables transaction to a user/role for review.

In one embodiment, the functional sensor system enables project managers to focus on exceptional transactions only, saving time by avoiding the need to review all bill transactions and decreasing the risk that exceptions are missed.

### —Overview of Solution Components—

In one embodiment, the functional sensor system incorporates one or more of the following elements into a framework for configuring and generating operational data signals for controls: Sensor, Signal, Signal Category, Source, and

### Action.

Sensor-User defined policies or sensors that are translated into implicit policies by the system and rules that are executed natively within the enterprise data system. These may also be referred to herein as “functional sensors” or “logical sensors”.

Signal-Signals are emitted by sensors when a rule (or policy) is satisfied. Signals may be electronic messages. The electronic messages used as signals may deliver a payload including an indication that the rule is satisfied, along with associated information.

Signal Category-Signal categories are extendable logical grouping of Signals that are emitted by the sensors, e.g. Business Process, Functional Metrics, Exceptions.

Source—A “source” (or “data source”) is a primary system that acts as the source of data for the sensors.

Action—An “action” is a computing task or computing activity that is performed based on the category of the signal.

### —Process Flow: Design Time—

FIG. 3 illustrates one embodiment of a process flow 300 for the functional sensor system at design time that is associated with a framework to configure and generate operational data signals for controls. In an out-of-the-box (un-edited) configuration 305, a functional (logical) sensor may be a template that lacks definition of a configuration. As initial input, functional sensors may be given a pre-defined or seeded definition 310. Defining the seeded definition 310 specifies data source(s) 330 within the ERP and conditions or criteria for triggering a signal 345 that may be satisfied, or not, based on values of the data sources 330 monitored by the sensor. The combined conditions for triggering a signal may be referred to herein as a policy 340 (or rule). And the seeded definition 310 may specify an action 350 to be taken in response to a given signal. The seeded definition 310 may assign a signal category 335 to the functional sensor.

The functional sensor system then registers the sensor metadata within the framework 315. The functional sensor system registers the sensor metadata within the framework 315 by creating or updating a data structure that describes the functional sensor within a metadata repository of the enterprise data system. In one embodiment, the metadata repository is an MDS (metadata services) repository. This enables the enterprise data system to recognize, load, and use the configured functional sensors at runtime.

The seeded definitions 310 may be re-configured by user input from customers or business users 320. New, custom, sensors (with custom policies) may be defined 325 by user input. The definitions of the sensors are added to a metadata repository of the ERP, causing the ERP to automatically execute the sensors.

### —Process Flow: Run Time—

At runtime, the enterprise data system activates or deploys functional sensor(s) that are registered in the metadata repository. FIG. 4 illustrates one embodiment of a process flow 400 for the functional sensor system at run time that is associated with a framework to configure and generate operational data signals for controls. The sensors monitor data sources 410 specified in the sensor definition for activity (such as ERP application create or modify transactions 405) that satisfies the policy (conditions) assigned to the sensor in the sensor definition. The relevant data from the sources 410 may be captured in real-time. The sensor evaluates the policy 420 for a given ERP application create or modify transaction 405. The policy is executed on data sensed from the sources 410 to determine whether or not to trigger emission of a signal 425 from the sensor. Where the policy of a sensor is satisfied 445, a signal is emitted 425 from the sensor. One or more consumers or recipients of the signal may be designated in the sensor definition. The emitted signal is transmitted to the consumers. In response to the signal alone, or in combination with other information, the consumer automatically initiates an action 430. For example, the action 430 may update the enterprise data system, send notifications, or perform other tasks of the enterprise data system.

In one embodiment, the sensor reads the policy definitions 435 from the metadata store. The sensor observes changes on the defined sources 440 of transaction changes. The sensor validates if the policy criteria are satisfied 445, and if so, emits a signal 425. The enterprise data system observes the signal and takes defined actions 450 in response to the signal.

### —Discussion of ERP Sensor Signaling: Overview of Example Scenarios—

Finance Departments around the world aim to complete the transaction entry and accounting of financial transactions within the defined business service level agreements (SLAs). Today the invoice processing lifecycle includes invoice import, validation and approval after which the invoice becomes ready for payment. In parallel, invoices must also be accounted such that the representation in General Ledger is accurate and up to date.

Customers attempt to identify the optimum frequency at which the various invoice processing related background processes must be scheduled to move the invoices efficiently through the processing life-cycle. To do this, the customers consider the daily invoice throughput as well as the SLA. Customers often end up defining very frequent schedules for background processes in the hope of achieving real-time transaction processing.

Setting up frequent schedules for background processes in an attempt to achieve real-time transaction processing causes a cascade of technical problems. Initially, the frequent scheduling causes: (1) background processes to run even when there are no transactions to process; and (2) downstream background processes to continue to run when transactions are stuck upstream (for example, invoices approval is not processing any transactions as invoices have not been successfully validated).

This unnecessary queuing of background processes results in the inefficient utilization of both machine and human resources. The increased number of background processes necessitates that the outcome be evaluated for empty runs, which is a waste of time and compute resources.

Running of downstream background processes when the upstream transaction processing is not yet complete results in transaction backlog upstream. This may then necessitate the ad-hoc submission of background processes as and when transactions move along in the lifecycle. For example, if a customer has scheduled initiating invoice approval workflow every 30 min but the invoice validation stage itself is not successful, then customers may take a batch of invoices to resolve the exceptions and then manually submit invoice validation and thereafter, invoice approval to move the invoices along.

As an example, one customer may have a global SLA of 48 hours for completing the AP invoice processing starting from importing invoices to having invoices validated with no data or business exceptions. This implies that all incoming invoices must be ready for payment within 48 hours. In the current business process, to ensure the adherence to SLAs, high volume processes like import, validation and approval are scheduled/initiated manually.

As another example, another customer may have scheduled their processes too frequently—as low as 5 mins—to ensure that the system is able to meet the growing transactional volume.

Therefore, the increasing transactional volumes calls for more efficient processing through the various stages. As of today, delays are introduced as existing scheduled processes run periodically and not when transaction readiness dictates.

To illustrate this further, an example customer may face problems in closing transactions during month-end due to greater transaction volume and slow performance of Payables ESS jobs resulting in delays to financial closing. The enterprise data system for the example customer in this case was not able to sense the processing needs based upon the number of transactions during month end close and therefore, faced issues closing and accounting the transaction on-time. Similar patterns can be observed in many customers. As month-end nears for another example customer, there is a nearly 150% increase in manually triggered AP (accounts payable) invoice approvals as system run schedules proves inadequate to sense the processing needs.

As a result, the enterprise data system produces transaction errors that prevent settlement. Financial users/departments then face additional manual work to reconcile errored transactions and to process the transactions on-time often resulting in settlement delays and cause breach of business terms/SLAs.

In one embodiment, implementation of functional sensors in accordance with the functional sensor systems and methods described herein resolves these and other technical problems. In one embodiment, the functional sensor systems and methods achieve real-time transaction processing while avoiding frequent background processing (and the attendant delays, wasted compute processing, and transaction errors) by predefining the conditions under which background processing is to occur, and waiting until the conditions are detected in the enterprise data system to perform the background processing. This scales the background processing to fit the need for the processing, thereby reducing or eliminating delays, wasted compute processing, and transaction errors.

Functional sensors define the conditions and criteria to support the following types of tasks:
1. Call data source (e.g., Business Object Spectra Services (BOSS)) Application Programming Interfaces (APIs) to perform create, read, update, or delete (CRUD) operations in an operational database such as Fusion DB.
2. Control when a business process stream (Thematic Business Process) comprising multiple individual tasks, should be executed end-to-end.
3. Control when individual process tasks should be executed.
4. To initiate an action such as a notification/alert. For example, initiate exception management.

The individual process tasks are atomic, self-contained and can be run independently to achieve a functional purpose (e.g. Import Invoices, Validate Invoices, Approve Invoices, Account Invoices etc.) when the criteria or condition is met.

The functional sensors are configured to pass parameters to the APIs, business process stream, or the individual tasks to define the scope of their run. For example, a functional sensor may identify that three ledgers satisfy a particular condition. The functional sensor is configured to create an event payload to list the three ledgers so that a BPO (Business Process Orchestrator) can execute the desired process for those ledgers only.

The functional sensors and functional sensor system is a shared infrastructure that is extensible to a wide variety of sensed activity beyond the examples described herein. Product-specific functional sensors may be registered into the ERP metadata repository to enable processes respective to the product to be automated in a touch-less way.

This Functional Service Architecture (FSA) of the functional sensor system defines: (1) Metadata for functional sensors and actions; and (2) Types of conditions and criteria, for example: (a) Attribute of an object—e.g. Trigger validation task-based status of the Invoice, (b) Volume—e.g. Trigger task when the number of invoices awaiting processing exceeds 300, (c) Time—e.g. Trigger task after 30 mins even if the number of invoices has not reached 300, (d) Schedule—e.g. Trigger invoice creation task on customer's billing date or after 30 mins. These types of conditions and criteria are triggering points for tasks such as policy evaluation. Tasks may be triggered on a schedule. Tasks may be triggered upon a change to monitored data. Additional conditions may also be specified for triggering the tasks.

### —Discussion of ERP Sensor Signaling: Concepts—

Functional Sensor.

In one embodiment, a functional sensor is a component or module that (primarily) monitors data in an enterprise data application. The functional sensor may monitor the data by way of BOSS shapes. The functional sensor may monitor the data on a designated data source. The functional sensor may monitor the data at a frequent interval. Based on the monitored data, the functional sensor may determine if certain business conditions are met. In response to the conditions being met, the functional sensor may execute or cause to be executed appropriate business action(s) or other task(s).

Example Purpose: One purpose of functional sensors is to help to improve the efficiency of operations in an enterprise data system (such as ERP operations or financial operations) by executing tasks (e.g., business actions) effectively at the right time.

Applicability: Functional Sensors are allowed on business objects defined on top of an operational data store or other data source to evaluate business conditions applied to data at rest and determine a most favorable time to execute business task(s) or other action(s). Functional sensors enable users to configure automation for a wide variety of actions such as automatic approvals, sending notifications, initiating new business processes, updating business objects to reflect change of state, etc.

A functional sensor may be invoked to perform its monitoring (to check whether data satisfies the conditions of the functional sensor) in a number of ways, including, but not limited to: (1) Event-Driven invocation—the functional sensor commences monitoring in response to occurrence of a pre-specified event occurring in, e.g., the monitored enterprise data system or a client system that consumes the output of the functional sensor; (2) Scheduled invocation—the functional sensor commences monitoring at fixed intervals; (3) Manual invocation—the functional sensor commences monitoring in response to receiving an express input by a user or administrator; (4) Polled invocation—the functional sensor commences monitoring in response to a signal from a monitoring agent that it has observed a threshold or pattern in conditions that the agent is polling; (5) Cascade or Chain invocation—the functional sensor commences monitoring in response to another functional sensor being triggered; (6) Machine Learning invocation—the functional sensor commences monitoring when a machine learning model predicts when a condition may become true and launches the functional sensor preemptively; (7) State Transition invocation—the functional sensor commences monitoring in response to a monitored system or process moves from one state (e.g. idle) to another state (e.g., running); or (8) External System Notification—the functional sensor commences monitoring in response to receiving a notification from an external system, for example via webhook, message bus, or a subscription.

Functional Sensor Category. Sensors may be categorized by a general type of action or task that the sensor is configured to trigger. Based on various ERP use cases, the following are some of the broader categories for functional sensors: approval, KPI (key performance indicator), notification, process automation, enrichment, holds, audit, and infrastructure. Sensor categories drive some of properties of a functional sensor, such as (1) whether a sensor is schedule driven, (2) whether any implicit business condition that is needed on a business object before the action defined in the sensor can be executed, or (3) whether batched notifications are allowed (in the case of approvals), etc.

A listing of example sensor categories with associated descriptions and sample use cases is shown in Table 1 below.

TABLE 1

| | Sensor | | |
|---|---|---|---|
| | Category | Description | Sample Use Cases |
| 1 | Approval | Functional grouping for all | Requirement: Auto Approve a |
| | | approval related use cases. | Purchase transaction if its |
| | | Options such as frequency of | validated and belongs to an |
| | | execution, implicit business | example business unit with an |
| | | condition to be applied for | amount value <$100 |

| | | |
|---|---|---|
| executing approval sensors and | Category: | Business |
| Routing documents individually | Approval | Object: |
| or as a batch can be defined at | | Purchase |
| this category. | | Transaction |

| | | | |
|---|---|---|---|
| | | Batch Approvals: approval | Defaults: |
| | | category sensors are validated | Schedule: 15 mins |
| | | for every transaction that meets | Implicit Business |
| | | the individual business | Condition: wfapproval |
| | | condition. Nevertheless, at | Status is ‘Required’ |
| | | category level, this option can | Notification Type: Single |
| | | be enabled to group all | |
| | | documents that meet the | |
| | | business condition together and | |
| | | trigger a single approval | |
| | | notification for them. This is | |
| | | called a batch approval | |
| | | scenario. | |
| | | When multiple transactions are | |
| | | batched together in a single | |
| | | approval sensor event, either all | |
| | | are approved together or | |
| | | rejected together. | |
| 2 | KPI | Functional grouping for any Key | Requirement: Calculate total |
| | | Performance Indicator (KPI) | amount due data point for |
| | | computation use cases across | Receivable Bills Receivable if |
| | | products | payment due date is before |
| | | | current date |

| | |
|---|---|
| Category: | Business |
| KPI | Object: |
| | Receivable |
| | Bills |
| | Receivable |

| | | | |
|---|---|---|---|
| | | | Defaults: |
| | | | Schedule: 24 Hour |
| 3 | Notification | Functional grouping for all | Requirement: Notify PO Buyer |
| | | notification use cases. | when Quantity variance hold is |
| | | | placed on Purchase Transaction |

| | |
|---|---|
| Category: | Business |
| Notification | Object: |
| | Payables |
| | Invoice Hold |
| | Activity |

| | | | |
|---|---|---|---|
| | | | Defaults: |
| | | | Schedule: Immediate |
| 4 | Process | Functional grouping for use | Requirement: Trigger Invoice |
| | Automation | cases on initiating Process | Process Automation for |
| | | Automation flows. | Purchase Transaction if ledger is |
| | | | India, unprocessed transaction |
| | | | volume is >=1000 and current |
| | | | date is between 1st Jan and |
| | | | 31st March. |

| | |
|---|---|
| Category: | Business |
| Process | Object: |
| Automation | Purchase |
| | Transaction |

| | | | |
|---|---|---|---|
| | | | Defaults: |
| | | | Schedule: 1 hour |
| 5 | Enrichment | Functional grouping for use | Requirement: Execute |
| | | cases involving enrichment | Revaluate Foreign Journal for |
| | | processes like general ledger | UK ledger when no. of Journals |
| | | (GL) Allocations, Revaluate | with Foreign Currency >10. |

| | | |
|---|---|---|
| Foreign Journal, etc. | Category: | Business |
| | Enrichment | Object: |
| | | Journal |

| | | | |
|---|---|---|---|
| | | | Defaults: |
| | | | Schedule: 15 days |
| 6 | Holds | Functional grouping for hold | Requirement: Release duplicate |
| | | resolution use cases. | invoice holds on Purchase once |
| | | | user corrects the transaction. |

| | |
|---|---|
| Category: | Business |
| Holds | Object: |
| | Payables |
| | Invoice Hold |
| | Activity |

| | | | |
|---|---|---|---|
| | | | Defaults: |
| | | | Schedule: Immediate |
| | | | Implicit Business |
| | | | Condition: hold release |
| | | | lookup is available |
| 7 | Audit | Functional grouping for audit | Requirement: Record audits for |
| | | related use cases of | changes in Payables Financial |
| | | configuration or security | Option setup whenever it is |
| | | changes. | modified. |

| | |
|---|---|
| Category: | Business |
| Audit | Object: |
| | Payables |
| | Financial |
| | Option |

| | | | |
|---|---|---|---|
| | | | Defaults: |
| | | | Schedule: Immediate |
| 8 | Infrastructure | Functional grouping for all | Requirement: Gather tables |
| | | infrastructure use cases like | Stats on General Ledger Tables. |

| | | |
|---|---|---|
| gather stats when staleness | Category: | Business |
| reaches 50% or defragment | Infrastructure | Object: |
| tables when there is | | Journal |

| | |
|---|---|
| fragmentation >40%. | Defaults: |
| | Schedule: Every day at 10 |
| | PM |
| | Implicit Business |
| | Condition: database (DB) |
| | statistics is stale |

Business Condition (Seeded & User Defined): A functional sensor derives a pre-seeded business condition from its associated category. The functional sensor applies the pre-seeded business condition implicitly along with any other additional business conditions defined by users to perform the indicated action(s). While the implicit business conditions are seeded, additional business conditions can be added by users. It also simplifies the setup options for approvals by including all such conditions as part of the functional sensor definition.

Frequency: Functional sensors of most categories can execute on business objects as per the default “as-shipped” frequency. The default frequency of execution for a functional sensor can also be overridden by users, for example to address business needs.

Action: Functional sensors on a business object in each category can perform either one action (or task) or a multiple set of actions (or tasks) upon meeting certain business conditions, as configured by users.

FIG. 5 illustrates examples for approval sensors 500 and examples for non-approval sensors 550 that are associated with a framework to configure and generate operational data signals for controls. Example functional sensor 1 505 triggers an approval action of automatic approval. The triggering logical object that functional sensor 1 505 monitors for satisfaction of the condition is a purchase transaction. Functional sensor 1 505 executes at a frequency of 15 minute intervals. The approval category causes functional sensor 1 505 to have an implicit business condition of if the purchase transaction requires approval. Finally, functional sensor 1 505 is configured to have a condition, policy, or rule that the purchase transaction is validated with an amount value less than $100, and belongs to a “vision” business unit.

Example functional sensor 2 510 triggers a notification action of automatically sending an email. The triggering logical object that functional sensor 2 510 monitors for satisfaction of the condition is a purchase transaction. Functional sensor 2 510 executes at a frequency of 1 hour intervals. And, functional sensor 2 510 is configured to have a condition, policy, or rule that the purchase transaction is created with the amount greater than $15,000 and the supplier is Advanced Network Systems.

Example functional sensor 3 515 triggers an approval action of automatic approval. The triggering logical object that functional sensor 3 515 monitors for satisfaction of the condition is a journal. Functional sensor 3 515 executes at a frequency of 6 hour intervals. The approval category causes functional sensor 3 515 to have an implicit business condition of if the ledger requires approval. Finally, functional sensor 3 515 is configured to have a condition, policy, or rule that the journal contains a name with “NON” and the current period is an adjustment period.

Example functional sensor 4 520 triggers an approval action of automatic approval. The triggering logical object that functional sensor 4 520 monitors for satisfaction of the condition is an asset retirement. Functional sensor 4 520 executes at a frequency of 5 hour intervals. The approval category causes functional sensor 4 520 to have an implicit business condition of if the asset retirement requires approval. Finally, functional sensor 4 520 is configured to have a condition, policy, or rule that the asset retirement contains a name like “FA % BOOK” and the cost of the asset is greater than or equal to $15,000 and the retired cost is less than or equal to $1000.

Example functional sensor 5 555 triggers a process automation action of triggering an invoice process automation. The triggering logical object that functional sensor 5 555 monitors for satisfaction of the condition is a purchase transaction. Functional sensor 5 555 executes at a frequency of 1 hour intervals. And, functional sensor 5 555 is configured to have a condition, policy, or rule that the ledger is India, the volume of unprocessed transactions is less than or equal to 1000, and the current date is in the first quarter of the calendar year.

Example functional sensor 6 560 triggers a KPI action of triggering a calculation of a data point: total amount due. The triggering logical object that functional sensor 6 560 monitors for satisfaction of the condition is a receivables bill receivable. Functional sensor 6 560 executes at a frequency of 24 hour intervals. And, functional sensor 6 560 is configured to have a condition, policy, or rule of if a payment due date of the receivable bill receivable is before the current date.

### —Discussion of ERP Sensor Signaling: Requirements—

A listing of requirements with associated requirement groups, solution components, capabilities, and consumers is shown in Table 2 below. (Note that as used herein, the term “requirement” indicates a feature specified by a user, and does not indicate that the feature is mandatory. Thus, the requirement is a may or may not be present in a given embodiment.)

TABLE 2

| | Requirement | Solution | | | |
|---|---|---|---|---|---|
| | Group | Components | Requirement | Capabilities | Consumer |
| 1 | Definition | Sensor | As an ERP User, I would | A surfaced catalog of the | Seeded - |
| | | Catalog | like to see what | available functional sensors | Created by |
| | | | functional sensors are | and their status. | Uptaking |
| | | | available and whether or | | Product |
| | | | not they are activated so | | User |
| | | | that I have a better | | Defined - |
| | | | understanding of what | | User has |
| | | | features are available | | Option of |
| | | | and which are being | | changing |
| | | | utilized. | | the sensor |
| | | | | | condition |
| | | | | | not the |
| | | | | | flow of |
| | | | | | TBP based |
| | | | | | on |
| | | | | | Telemetry |
| | | | | | gathered |
| 2 | Definition | Sensor | As a Product Owner, I | Ability to seed Functional | WorkArea |
| | | Catalog | would like to be able to | Sensor definitions that will | Manager |
| | | | define functional sensors | trigger actions such as | ERP |
| | | | and the conditions | notifications and tasks in the | Implementa- |
| | | | governing when the | Business Process | tion |
| | | | defined actions are | Orchestration. | |
| | | | executed so that I can | Ability to define grouping | |
| | | | automate the execution | criteria within a functional | |
| | | | of my defined business | sensor to govern how the | |
| | | | streams and tasks. | data is grouped. For | |
| | | | | example, The count of | |
| | | | | invoices grouped by | |
| | | | | Business Unit and Source. | |
| | | | | sensors that have multiple | |
| | | | | schedules governing when | |
| | | | | then fire. | |
| | | | | For a functional sensor, the | |
| | | | | ability to define: | |
| | | | | Sensor Identifier | |
| | | | | Sensor Name | |
| | | | | Description | |
| | | | | Owning Product Team | |
| | | | | (e.g. AP, AR, etc.) | |
| | | | | Action Type (Task or | |
| | | | | Business Process) | |
| | | | | Action Properties (e.g. | |
| | | | | Business Process Name, | |
| | | | | Task Name) | |
| | | | | Enabled Flag | |
| | | | | Created By | |
| | | | | Creation date | |
| | | | | Last Updated Date | |
| | | | | Last Updated By | |
| | | | | Seeded Flag | |
| | | | | Sensor Priority | |
| | | | | Execution Method | |
| | | | | (Scheduled, Data Change | |
| | | | | Events, etc.) | |
| | | | | Event Rules | |
| | | | | Multiple Conditions | |
| | | | | comprising: | |
| | | | | Condition Type (e.g. | |
| | | | | Time-Based, LBO) | |
| | | | | LBO (Multiple) | |
| | | | | LBO Join Conditions | |
| | | | | LBO Filters | |
| | | | | Fact (the attribute(s) | |
| | | | | to be checked) | |
| | | | | Logical Operators | |
| | | | | Comparison | |
| | | | | Operators | |
| | | | | Parentheses for | |
| | | | | precedence | |
| | | | | Aggregation | |
| | | | | Functions | |
| | | | | Values (Checked | |
| | | | | against the facts) | |
| | | | | including: Threshold | |
| | | | | Values and Timeout | |
| | | | | Values | |
| | | | | Grouping Criteria | |
| | | | | Modifiable Flag | |
| | | | | Actions (Array) | |
| | | | | Action Type (e.g. | |
| | | | | Business Event, API, | |
| | | | | Email) | |
| | | | | Action Specific | |
| | | | | Attributes (e.g., Email | |
| | | | | Addressees, Business | |
| | | | | Event Name, etc.) | |
| | | | | Additional Parameters | |
| 3 | Definition | Sensor | As a Product Owner, I | For an Event raised by | Seeded - |
| | | Catalog | want the functional | Functional Sensor: | Uptaking |
| | | | sensors to execute | Sensor Name | Product |
| | | | BOSS APIs, business | Action Type (e.g. Process, | User |
| | | | process streams and/or | Task, Exception, | Defined - |
| | | | tasks passing any | Notification, Email, etc.) | WorkArea |
| | | | required parameters in | Priority | Manager |
| | | | the payload so that | Timestamp | |
| | | | manual intervention is | Priority (to be considered | |
| | | | not required. | by BPO, etc.) | |
| | | | | Action | |
| | | | | Payload | |
| 4 | Definition | Sensor | As an ERP User, I would | Ability to define multiple | |
| | | Catalog | like a functional sensor | actions that will result in | |
| | | | to be able to initiate | multiple events emitted by a | |
| | | | multiple actions so that I | Functional Sensor | |
| | | | can accomplish the | | |
| | | | complete business | | |
| | | | objective without manual | | |
| | | | intervention or multiple | | |
| | | | steps (e.g. initiate | | |
| | | | stream, send email, etc.) | | |
| 5 | Definition | Sensor | As an ERP User, I would | End-to-end Execution: Ability | |
| | | Catalog | like my processes, | to define functional sensors | |
| | | | comprising of multiple | that trigger all tasks within a | |
| | | | individual tasks, to be | Business Process Stream. | |
| | | | executed automatically | | |
| | | | based upon defined | | |
| | | | conditions and without | | |
| | | | manual intervention so | | |
| | | | that the business | | |
| | | | transaction are | | |
| | | | processed in a timely | | |
| | | | manner and in | | |
| | | | accordance with my | | |
| | | | SLAs/Priorities. | | |
| 6 | Definition | Sensor | As an ERP User, I would | Single Task Execution: | |
| | | Catalog | like to execute individual | Ability to define functional | |
| | | | tasks to be executed | sensors that trigger an | |
| | | | automatically based | individual standalone task or | |
| | | | upon the defined | an individual task within a | |
| | | | conditions and without | business process. | |
| | | | manual intervention so | | |
| | | | that my business | | |
| | | | transactions are | | |
| | | | processed in a timely | | |
| | | | manner and in | | |
| | | | accordance with my | | |
| | | | SLAs/Priorities. | | |
| 7 | Definition | Sensor | As an ERP User, I would | Ability to specify priority of | |
| | | Catalog | like my processes and | the tasks to the Business | |
| | | | tasks to be processed | Process Orchestration. | |
| | | | based upon the defined | Tasks should be executed in | |
| | | | priority so that my | priority order by the Business | |
| | | | business transactions | Process Orchestration. | |
| | | | are processed in a timely | | |
| | | | manner and in | | |
| | | | accordance with my | | |
| | | | SLAs/Priorities. | | |
| 8 | Definition | Sensor | As an ERP User, I would | Ability to define functional | |
| | | Catalog | like to schedule when | sensors that have multiple | |
| | | | processes or tasks run | schedules governing when | |
| | | | so that I can better meet | they fire. | |
| | | | the needs of my | | |
| | | | business. | | |
| 9 | Configuration | Internal | As a Product Owner, I | Ability for product teams to | |
| | | Uptake / | would like to be able to | seed functional sensors. | |
| | | Factory | seed metadata for | | |
| | | Setting | functional sensors so | | |
| | | | that a catalog of | | |
| | | | functional sensor is | | |
| | | | available out of the box | | |
| | | | for customer to use. | | |
| 10 | Configuration | Internal | As an ERP User, I would | Ability to create and manage | |
| | | Uptake / | like to be able to create | functional sensors. | |
| | | Consumer | my own functional | | |
| | | Onboard- | sensors so that I can | | |
| | | ing | better meet the needs of | | |
| | | | my business. | | |
| 11 | Configuration | Internal | As an ERP User, I would | Ability to manually amend | |
| | | Uptake / | like to manually amend | thresholds and timeouts of | |
| | | Consumer | the thresholds and time | seeded functional sensors. | |
| | | Onboard- | outs specified for the | | |
| | | ing | seeded functional | | |
| | | | sensors to that I may | | |
| | | | customize them to better | | |
| | | | meet my business | | |
| | | | practices. | | |
| 12 | Configuration | Internal | As an ERP User, I would | Ability to automatically adjust | |
| | | Uptake / | like to the thresholds and | thresholds and timeouts of | |
| | | Consumer | timeouts specified for | seeded functional sensors | |
| | | Onboard- | functional sensors to | based upon run history and | |
| | | ing | automatically adjust | the data. | |
| | | | based upon my | | |
| | | | transactional history so | | |
| | | | that my transaction are | | |
| | | | processing is optimized | | |
| | | | in accordance with my | | |
| | | | SLAs/Priorities. | | |
| 13 | Configuration | Internal | As an ERP User, I want | Ability to pause functional | |
| | | Uptake / | to be able to pause all or | sensors - all or individually. | |
| | | Consumer | specific sensors so that I | | |
| | | Onboard- | am better able to | | |
| | | ing | manage which sensors | | |
| | | | run. | | |
| 14 | Runtime | Execution | As an ERP User, I do not | Functional Sensors should | |
| | | | want jobs that may clash | not fire if the task or a | |
| | | | to run at the same time | business stream containing | |
| | | | so that my transactions | the task is already running. | |
| | | | are processed | | |
| | | | successfully and as | | |
| | | | efficiently as possible. | | |
| 15 | Runtime | Monitoring | As an ERP User, I would | Ability to configure | |
| | | | like to control the | monitoring frequency, i.e. the | |
| | | | frequency at which the | frequency of which the rules | |
| | | | functional sensors run so | of a functional sensor are | |
| | | | that I am able to | evaluated against the source | |
| | | | customize to better suit | data. | |
| | | | the needs of my | | |
| | | | business. | | |
| 16 | Operational | Perform- | As a cloud ERP provider, | To prevent degradation of | |
| | | ance | I do not want ERP Users | performance, Implement | |
| | | | to configure their | Guardrails to govern the | |
| | | | functional sensors in a | following: | |
| | | | way that over utilizes the | Thresholds | |
| | | | available resources so | Timeouts | |
| | | | that performance issues | Monitoring | |
| | | | are avoided and | Frequency | |
| | | | workloads are effectively | Notifications/ | |
| | | | balanced. | Emails/Alerts | |
| 17 | Operational | Perform- | As an ERP User, I would | Ability to see estimates of the | |
| | | ance | like to see impact | number of events that will be | |
| | | | projections should I | raised when creating or | |
| | | | amend thresholds or | amending a functional sensor | |
| | | | timeouts, or when | so that customers can see | |
| | | | creating a functional | the potential performance | |
| | | | sensor so that I can | implications of their | |
| | | | avoid any overutilizing | functional sensor. | |
| | | | the available resources. | | |
| 18 | Operational | Logging / | As an ERP User, I would | Ability to log runtime history | |
| | | Telemetry | like to be able to see | of sensors - when monitoring | |
| | | | how the functional | daemon is run and when | |
| | | | sensors are performing | events are raised. | |
| | | | so that I can take any | Functional Sensor statistics | |
| | | | necessary actions to | should be surfaced with | |
| | | | improve processing. | recommended actions for | |
| | | | | poorly performing sensors. | |
| | | | | The statistics should include: | |
| | | | | Dashboard showing | |
| | | | | summary of sensor | |
| | | | | statistics | |
| | | | | No of time a monitoring | |
| | | | | daemon is run | |
| | | | | Average time for run | |
| | | | | How many times an event | |
| | | | | is raised | |
| | | | | Percentage of runs where | |
| | | | | an event is raised (Low | |
| | | | | percentage would indicate | |
| | | | | that monitoring frequency | |
| | | | | should be reduced) | |

### —Discussion of ERP Sensor Signaling: Use Case Patterns—

A functional sensor has an associated triggering condition (criteria/rule/policy), that is evaluated at some periodicity or frequency, and actioned upon the condition being satisfied. The actioning is performance of an action or task, e.g., raise an event to execute an atomic process, notify someone, etc. A variety of example use case patterns follow.

Use Case: Enterprise Scheduler Service (ESS) Job Elimination. In this use case, the functional sensor system performs lightweight approvals. The functional sensor system may be configured to auto-approve payables invoices automatically by way of BOSS API. The functional sensor system is configured to operate one or more functional sensors that, based upon defined criteria, automatically approve the payables invoices once they have been validated or send the payables invoices to Business Process Management (BPM) for manual approval if they are not validated.

Use Case: ESS Job Simplification. In this use case, the functional sensor system automates and simplifies invoice validation. The functional sensor system may be configured to operate a functional sensor that detects when payables invoices have been imported, and automatically initiate invoice validation. The functional sensor system may be further configured to simplify invoice validation by: (1) operating a functional sensor to detect when import has completed and then automatically initiating tax calculations in batch; and (2) operating a functional sensor to detect when tax calculations are complete and then automatically initiate core validations and optional processing.

Use Case: Transaction volume/amount/date-time patterns. In this case the functional sensor system is configured to launch tasks based on satisfying patterns of volume, amount, or date-time using a variety of functional sensors. The functional sensor system may be configured to operate a functional sensor that runs a validate payables invoices process immediately when an unvalidated invoices >n threshold is met. The functional sensor system may be configured to operate a functional sensor that runs a validate payables invoices process immediately only for business units where Unvalidated Invoices >n threshold is met. The functional sensor system may be configured to operate a functional sensor that runs the create accounting process when receivables invoice amount>$n threshold is met. The functional sensor system may be configured to operate a functional sensor that runs a payables invoice Import process at 8 am PST every day. The functional sensor system may be configured to operate a functional sensor that runs a payables invoice validation hourly from 10 am to 4 pm every day. The functional sensor system may be configured to operate a functional sensor that runs a payables invoice import every 30 mins for a given business unit (BU). The functional sensor system may be configured to operate a functional sensor that runs an accounts payable (AP) invoice stream immediately for invoices from Supplier ‘ABC’. For example, a client may be very sensitive to paying invoices promptly for high-priority suppliers such as data center provider or supplier providing parts for manufacturing. An example client may have many invoices with immediate payment terms that need to be paid right away.

Use case: Financials/Subledger period patterns. In this case the functional sensor system is configured to launch tasks based on timing associated with financials and ledgers. The functional sensor system may be configured to operate a functional sensor that runs the period close process group every day for n days before accounting period close date threshold is met. The functional sensor system may be configured to operate a functional sensor that runs the translate balances process everyday for n days starting n days after an accounting period close date threshold is met. The functional sensor system may be configured to operate a functional sensor that runs revaluation every 4 hours starting, at 12:00 AM PST; for 1 day after period close date. The functional sensor system may be configured to operate a functional sensor that runs the projects period close process group everyday for n days before a project accounting period close date threshold is met.

Use Case: Sleep/Awake patterns. In this case, the functional sensor system may be configured to operate a functional sensor that runs a publish hierarchies process when segment values are imported AND no ESSBASE user sessions for n minutes threshold is met.

Use Case: Processing Window pattern. In this case, the functional sensor system may be configured to operate a functional sensor that notifies recipients when a task or process stream exceeds a processing window, for example, Automated Health Check System (AHCS) data ingestion to accounting process stream has to complete in a 2 hour window between 9 PM to 11 PM PST for further downstream events.

Use Case: Lockdown processes pattern. In this case, the functional sensor system prevents the execution of a designated process during a window of time between a start time and an end time: do not run “x” process in this window. The functional sensor system may be configured to operate a functional sensor that detects an attempt by the ERP to initiate the designated process at a time within the window, and emits a signal configured to terminate the designated process or otherwise prevent the designated process from running

For example, a customer may execute hundreds of integrations in a short overnight period to bring data into AP Interface, do not run Invoice Import and subsequent processes during this time. During critical period such as period close, users should be able to restrict processes, such as (1) Freeze Chart of Accounts and hierarchy changes via Publish Hierarchies process from period close date −3 to period close date; or (2) Prevent inherit segment value attributes from Period close date −5 to Period close date +1.

Use case: System Resource patterns. In this case, the functional sensor system manages the load placed on system resources. The functional sensor system may be configured to operate a functional sensor that runs processes based on process priority. For example, the Posting process has higher priority than other General Ledger processes. The functional sensor may detect when a post has been initiated where other general ledger actions are ahead of the post in the queue, and signal to initiate a task that advances the post to the head of the queue. The functional sensor system may be configured to operate a functional sensor that runs a process when there are no incompatible processes running. E.g., run the Publish Hierarchies process when the Posting process is NOT running for a given Ledger. The functional sensor may detect when the posting process is running, and signal to pause or not start the Publish Hierarchies process. The functional sensor system may be configured to operate a functional sensor that runs the Online Accounting process when Online Accounting Request Records >n AND Accounting Request Status=Unaccounted threshold is met. The functional sensor system may be configured to operate a functional sensor that stops an Online Accounting process when Online Accounting Request Records <n AND Accounting Request Status=Unaccounted threshold is met.

### —Discussion of ERP Sensor Signaling: High Level Overall Architecture—

FIG. 6 illustrates one embodiment of an functional sensor system 600 showing integration with other frameworks that is associated with a framework to configure and generate operational data signals for controls. FIG. 6 shows one possible example of how a functional sensor system may be integrated into an enterprise data system, such as an ERP system. The dotted-box 605 in the diagram shows where data observability 651 and the functional sensors 657 sit within the overall touchless processing solution (“touchless” meaning herein that the monitoring by the functional sensors 657 need not directly interact with or disrupt the ordinary data flow). functional sensor system 600 is shown as an end-to-end architecture for data ingestion, event-driven processing, and exception handling when employing functional sensors in an enterprise data system. In one embodiment, functional sensor system 600 includes interface 610, ERP integration service 615, thematic business processes 620, telemetry 625, and exception management 630.

Interface 610 is an entry point for data entering the ERP environment from external sources-such as B2B connections, partner integrations, or other ecosystems. Interface 610 funnels incoming files or streams to ERP Integration Service 615. B2B connected ecosystem 631 channels transactional data into the ERP integration service 615 from external financial institutions or partner businesses (e.g., JPMorgan Chase or Bank of America). External iPaaS integration 633 channels transactional data into the ERP integration service 615 from third-party integration platforms (e.g., Oracle Integration Cloud, Boomi, MuleSoft). Trading partner integration 635 channels transactional data into the ERP integration service 615 from electronic invoicing (e-invoicing) and other supply-chain data exchanges. SaaS/PaaS Service Integration 637 channels transactional data into the ERP integration service 615 from cloud-based applications or platforms. FBDI (File-Based Data Import) 639 is a method for bulk-loading data into to the ERP integration service 615 from files or other data structures.

ERP integration service 615 handles the ingestion, preprocessing, and routing of incoming transaction data into downstream components. ERP integration service 615 applies checks and validations to incoming transaction data to ensure that the transaction data conform to expected formats, raising events for any anomalies detected and preparing valid records for further processing. ERP integration service 615 may obtain transaction data through at least two techniques: data file ingestion APIs 641 and real-time data stream subscriptions 643. Data file ingestion API 641 offers an endpoint for uploading files of various types that contain transaction data into the ERP integration service. Real-time data stream subscription 643 processes continuous feeds of transaction data from external systems. Once transaction data has arrived through data file ingestion API 641 or real-time data stream subscription 643, file evaluation for sanity 647 checks incoming transaction data for fundamental validity: file evaluation for sanity 647 performs virus scans, format checks, appropriate size checks, and correct unpacking (e.g., unzip). Optionally, product pre-processing validations 649 may verify that expected configuration or metadata elements exist before the transaction data enters the enterprise data system.

The transaction data is then written into operational database 660 and made available as for data observability events 651. Operational database 660 is a working database of data-in-motion, which is serving data to customers. The changes to the transaction data—also referred to herein as transaction changes—in operational database 660 are transferred to read-optimized data store 655. Read-optimized data store 655 is a database of data-at-rest, and includes the subset of transaction records that have been changed, rather than the set of all transaction records in operational database 660. Where the number of signals may be large, serving the functional sensors 657 directly from the operational database 660 may excessively consume the compute resources of operational database 660 and adversely affect the service to customers. Use of the read-optimized data store 655 avoids this challenge. The functional sensors 657 are able to analyze the changes as and when the transaction changes are transferred from the operational database 660 into the read-optimized data store 655. Thus, in one embodiment, the functional sensors 657 are served on the transferreddata from read-optimized data store 655. In another embodiment, the functional sensors are served on the live data from operational database 660.

Data observability events 651 are captures, from transaction data monitored as it flows through the enterprise data system, of those events that are relevant to the functional sensors. Data observability events 651 are passed to functional sensors 657 for evaluation against the conditions for emitting a signal. Data observability events are published to an event queue 653 (such as an OCI queue) for subsequent handling by thematic business process 620.

Thematic business process 620 manages domain-specific workflows, such as invoice validation, approval, or accounting tasks. In response to signals from functional sensors, thematic business process 620 orchestrates performance in the ERP of the tasks 672 that are indicated by the sensors. Business process orchestrator 670 coordinates the sequence of tasks 672 (import, validate, etc.). Business process orchestrator 670 receives the events (transaction changes) from event queue 653, as well as signals from functional sensors regarding the events, and then determines which task(s) 672 should be run, and in what order the tasks 672 should be run. Registered task metadata 674 contains the definitions, parameters, and rules associated with tasks 672, and which specifies how a task should be invoked, what inputs the task needs, and which ERP objects or data the task acts upon.

Telemetry 625 provides monitoring and diagnostic capabilities to observe both technical performance (e.g., latency, throughput) and business progress (e.g., transaction milestones). Telemetry 625 captures both transaction data and operational data that may be consumed by the functional sensors, and places the captured data into operational database 660. ERP databases other than operational may also be used. Operational monitoring 662 captures performance metrics (e.g., throughput, job durations), logs, and debugging details for the various ERP processes. Business monitoring 664 tracks key performance indicators and milestone stages within end-to-end processes, such as how many invoices successfully passed validation in a given time.

Exception management 630 encompasses processes for handling exceptions-potentially problematic events from upstream processes. Ingestion 680 collects the transaction records that were flagged as exceptions (e.g., by file evaluation for sanity 647 or product pre-processing validations 649 of ERP integration service 615). Exception management 630 creates summarized exceptions 681, which retains the basic data about the exceptions. Exception management 630 directs the summarized exceptions 681 into further exception categorization 683 and/or assigns them to attention of specific user roles 685 (personnel or teams responsible for handling particular categories of exceptions). Processing 687 corrects exceptions and retries and/or confirms the exceptions as resolved once the corrections have been made. Notification of the resolution or failure of resolution may be returned to the invoker.

### —Discussion of ERP Sensor Signaling: On-Boarding Flow—

FIG. 7 illustrates one embodiment of an on-boarding flow 700 that is associated with a framework to configure and generate operational data signals for controls. At block 705, customers review the seeded functional sensors. The customers may confirm or adjust the data sources, implied conditions, or other seeded variables. At block 710, customers review the conditions and actions that are associated with the seeded functional sensors. Customers may confirm or adjust the conditions and actions. At block 715, customers review the seeded threshold(s), timeouts, and frequency for the functional sensor. These seeded thresholds, timeouts, and frequency, too, may be confirmed or adjusted by the customers. At block 720, customers may create any schedules for the functional sensors to meet requirements of the customers. At block 725, the customers enable the functional sensor, as configured by the customer, in the functional sensor system. For example, the customer may register the functional sensor with the metadata repository of the enterprise data system. At block 730, customers cancel any current schedules that may have been created for the processes that are now driven by the functional sensor. Such schedules may conflict with or be duplicative of event-driven operation in response to signals from the functional sensor.

### —Discussion of ERP Sensor Signaling: Runtime Execution Flow—

Polling Data Source FIG. 8 illustrates one embodiment of a runtime execution flow 800 for polling a data source that is associated with a framework to configure and generate operational data signals for controls. The runtime execution flow 800 operates components in three process layers: an application layer 805, a sensor layer 810, and a rule engine layer 815. Operational database 820 and read-optimized data store 825 are in the application layer 805. In sensor layer 810, sensor repository 830, functional sensor 835 operate to determine if the rule criteria are met 840, triggering the functional sensor system to execute action 845. Rule engine 850 (e.g., Mercury rule engine) and rule repository 855 are in rule engine layer 815.

At reference 1 860, data source (here, read-optimized data store 825) will be polled to detect any changes. At reference 2 865, the sensor 835 process: (a) identifies which sensors are associated with the BO (business object) and CRUD (create, read, update, delete) event; and (b) links to the associated rule in the rule engine 850. At reference 3 870, the sensor definition (stored in sensor repository 830) details: (a) the business object definition; (b) the Trigger (CRUD event); and (c) the Rule (link to rule definition). At reference 4 875, the rule engine 875: (a) identifies rule and conditions associated with the rule ID passed from the sensor 865 process; (b) runs the rule against the BO; (c) returns True or False to indicate if the rule criteria has been met. At reference 5 880, the rule engine 850 returns True or False depending upon whether or not the rule criteria was met. At reference 6 885, the actions may include (a) BOSS API; (b) SOA Workflow; (c) BPO Process; (d) Notification; or other actions.

Data Source CDC Events. FIG. 9 illustrates one embodiment of a runtime execution flow 900 for data source Change Data Capture (CDC) events that is associated with a framework to configure and generate operational data signals for controls. In runtime execution flow 900, polling for transaction change events is replaced with enqueuing CDC events an event queue 905 (e.g., OCI queue).

At reference 1 910, the CDC event details (a) BOSS object; and (b) CRUD event. At reference 2 915, the sensor process: (a) identifies which sensors are associated with the BO and CRUD event; and (b) links to the associated rule in the rule engine. At reference 3 920, the sensor definition details: (a) the BOSS object; (b) the Trigger (CRUD event); and (c) the Rule (link to rule definition). At reference 4 925, the rule engine: (a) identifies rule and conditions associated with the rule ID passed from the sensor process; (b) runs the rule against the BO; (c) returns True or False to indicate if the rule criteria has been met. At reference 5 930, the rule engine returns True or False depending upon whether or not the rule criteria was met. At reference 6 935, the actions may include (a) BOSS API; (b) SOA Workflow; (c) BPO Process; (d) Notification; or other actions.

FIG. 10 illustrates one embodiment of an execution flow 1000 that is associated with a framework to configure and generate operational data signals for controls. Execution flow 1000 occurs across several process layers: a product team layer 1005 of activities performed by a product development team to set up a functional sensor, a customers layer 1010 of activities performed by customers to configure the functional sensor; an application layer 1015 of activities performed by the enterprise data system, and a runtime layer 1020 for the functional sensor.

The product team initially registers a logical business object for the functional sensor 1025, defining an association between the functional sensor and the logical business object. Optionally, the product team may seed a default schedule and/or an implicit business condition 1030 for the functional sensor. And, optionally, the product team may seed notification attributes 1035 for the functional sensor. The configuration information provided by the product team is assigned to the functional sensor in the functional sensor metadata repository 1065.

Customers may then create functional sensors 1040 for their particular conditions. Where the functional sensor is of an approvals type of sensor, the customer may also define exception based manual review and approvals 1045. Optionally, customers may further extend the notification template 1050 that may have been initially seeded by product team (at 1035). The configuration information provided by the customers is assigned to the functional sensor in the functional sensor metadata repository 1065.

The enterprise data application operates to create documents or transactions 1055. The enterprise data application adds the documents or transactions into a operational database 1060.

At runtime for the functional sensor, transaction change data is transferred from operational database 1060 to read-optimized data store 1070. Functional sensor 1075 observes the changes added to read-optimized data store 1070. Functional sensor 1075 is configured according to the definition provided by customers and the product team, based on the information stored in functional sensor metadata repository 1065. Functional sensor 1075 evaluates the observed changes against the conditions (e.g., business conditions) specified the definition for the functional sensor 1075 to determine if the conditions are met 1080.

Where the conditions are met 1080, the enterprise data system is triggered to perform an action. The possible actions include (but are not limited to) auto-approve or auto-reject 1082, exception-based manual review and approvals 1084, auto-resolve holds 1086, execute infrastructure maintenance 1088, initiate process flow 1090, and send notification 1092.

### —Discussion of ERP Signaling: Solution Components Overview—

Table 3 shows a list of components of an example functional sensor system and their associated component types and change types.

TABLE 3

| Component Name | Component Type | Change Type |
|---|---|---|
| Functional Sensor | Metadata | New |
| Sensor Categories | Metadata | New |
| Business Conditions | Metadata | New |
| Sensor Actions | Metadata | New |
| Action Event | Event | New |
| Sensor Schedules | Metadata | New |
| Sensor Process | Background Process | New |
| Event Queues | Table/Queue | New |

### —Discussion of ERP Sensor Signaling: Solution Components Details—

Functional Sensor. Functional sensors include metadata which define the sensor details such as its name, function, and whether or not it is enabled.

A functional sensor can be triggered in response to data change. Here, sensor execution is based upon data changing in an object, such as the creation of an invoice or a change in invoice's status. For example, sensors will be triggered by Change Data Capture (CDC) events in a data source. Or, in another example, CDC events are not used, and instead, the data source will be polled periodically to detect changes.

A functional sensor can be triggered in accordance with a schedule. The sensor is scheduled to run periodically, at a particular point in time, or at a point in time relative to an occasion such as close of a quarter, close of a year, or other occasion.

In one embodiment, the CRUD events may be abstracted for the customers as they might be unaware when a record in a table is being created, updated, etc. In this configuration, the possible events are defined for each object. For example, for Payables Invoice BO, the events might be: “Invoice Created” or “Invoice Updated”.

A functional sensor is associated with a BOSS object or view and will be triggered when there is a CRUD event or at a schedule defined by Sensor Schedules. A functional sensor has an associated Rule and Actions. The rules define the conditions which govern when the associated actions will be executed.

Product teams may seed the metadata of Functional Sensors for initial releases.

Functional Sensor Categories. Based on various ERP use cases, the following Table 4 lists some examples of the broader categories for functional sensors. Sensor categories drive some of the common properties like whether a sensor is schedule driven, any implicit business condition is needed on a Business object before the action defined in the sensor can be executed, or batched notifications being allowed (for approvals case only), etc.

TABLE 4

| | Sensor | |
|---|---|---|
| # | Category | Description |
| 1 | Approval | Functional grouping for all approval related use cases. |
| | | Options such as frequency of execution, implicit |
| | | business condition to be applied for executing |
| | | approval sensors and Routing documents individually |
| | | or as a batch can be defined at this category. |
| | | Batch Approvals: approval category sensors are |
| | | validated for every transaction that meets the |
| | | individual business condition. Nevertheless, at |
| | | category level, this option can be enabled to group all |
| | | documents that meet the business condition together |
| | | and trigger a single approval notification for them. |
| | | This is called a batch approval scenario. |
| | | When multiple transactions are batched together in a |
| | | single approval sensor event, either all are approved |
| | | together or rejected together. |
| 2 | KPI | Functional grouping for any KPI computation use |
| | | cases across products. |
| 3 | Notification | Functional grouping for all notification use cases. |
| 4 | Process | Functional grouping for use cases on initiating Process |
| | Automation | Automation flows. |
| 5 | Enrichment | Functional grouping for use cases involving |
| | | enrichment processes like GL Allocations, Revaluate |
| | | Foreign Journal, etc. |
| 6 | Holds | Functional grouping for hold resolution use cases. |
| 7 | Audit | Functional grouping for audit related use cases of |
| | | configuration or security changes. |
| 8 | Infra- | Functional grouping for all infrastructure use cases |
| | structure | like gather stats when staleness reaches 50% or |
| | | defragment tables when there is fragmentation >40%. |

Business Conditions. Business conditions (also referred to occasionally herein as rules or policies) define the criteria associated with a functional sensor. When the criteria are satisfied, the actions associated with the sensor will be executed.

Each business condition can have multiple child criteria defined. The business condition will utilize a rule platform (including a rule engine) for definition and execution. The rule platform is passed the business condition ID and associated BO for the functional sensor. The rule platform then retrieves the corresponding rule and evaluates its conditions against the BO. If the criteria specified are met, then the rule platform will return True to the functional sensor. Otherwise, false will be returned. If True is returned from the functional sensor, then the associated action will be executed.

Sensor Actions. Actions define which activities are executed when the conditions associated with a functional sensor are satisfied. Individual actions are associated with an action type which defines the type of action. A set of action properties is defined for the individual action types. So, for example, as shown in Table 5:

TABLE 5

| Action Name | Action Type | Action Property |
|---|---|---|
| Execute AP Invoices | Process (BPO) | Process Name |
| Stream | | |

One example action type is BOSS API and SOA Workflow. This action type supports use cases for payables auto-approvals. Other examples of action types include Process (BPO) and Tasks (BPO), API, FYI/Bell/Ask Provider Notification, Email, Exception, and Business Event.

Action Events. Action events are electronic messages or signals to perform an action that are emitted by functional sensors. Action events are either executed immediately or are JSON messages that are published to queues. The action events contain properties specific to the action being executed. In the case of business process orchestration, the process or task identifier should passed as part of the payload. The payload should also include any parameters that the BPO should use to drive the process or tasks. For example, if a functional sensor checks which ledgers have reached a threshold of 1000 invoices in order to be processed, then the ledgers which have satisfied this condition should be passed to the business process orchestrator so that the subsequent process run for those ledgers only.

In addition, the event should detail the information in the following Table 6 following for a BPO Process or Tasks:

TABLE 6

| Attribute | Details |
|---|---|
| Sensor Identifier | Unique Sensor Identifier that created the event. |
| Sensor Name | Display Name for the Sensor. |
| Task Priority | The priority of the action which should be |
| | considered by the BPO. |
| Timestamp | Date and Time that the event was created. |
| Action Type | Process or Task |
| BPO Identifier | The Process or Task Unique Identifier |
| BPO Name | Display name of the Process or Task. |
| Parameters | Name value pairs for any parameters passed. |

For example, as shown in Table 7:

TABLE 7

| | |
|---|---|
| Sensor Identifier | 11 |
| Sensor Name | payables-invoices-import |
| Task Priority | −1 |
| Timestamp | 2022-11-10 17:10:21.123 |
| Record Count | 1007 |
| Timeout Flag | false |
| Action Type | Process |
| BPO Identifier | 15699 |
| BPO Name | ERP_AP_INVOICE_STREAM |
| Parameters | ledgers: 1017, 1021, 1035 |

Event Queues. The action events are written to either a table or a queue (such as event queue 653) and there may be multiple queues for differing priorities.

Sensor Process. The sensor process subscribes to the data source CDC Event Queue. The sensor process processes events and then: (1) identifies to which BO the CDC event relates; (2) retrieve the sensors defined for that BO; (3) passes the sensor details (associated rule ID, BO) to the rule engine. The rule engine will return true if the rule conditions have been met. If True is returned, then (4) the associated action is directly executed or an event is published to a queue.

Sensor Process-Data Change Sensors. When a CDC event is identified for an object, then the data change type functional sensors defined for that object will be executed. In one embodiment, the sensor process may be configured to only execute functional sensors that are enabled and only check rules that are enabled. In one embodiment, the sensor process is configured to honor the priority assigned to the functional sensors to ensure that the functional sensors are processed in the appropriate order.

Sensor Process-Scheduled Sensors. In one embodiment, the sensor process is configured to check sensor schedules to see when the sensor should be evaluated. The default is continuously but for less frequent events, a scheduled can be defined. The sensor process is configured not to run the functional sensors if an event has been previously queued for the same parameters and remains unprocessed. Otherwise, multiple duplicate events may be raised unnecessarily causing extra processing in the BPO.

The sensor process is configured to, as it runs, record the following information of Table 8 in a log:

TABLE 8

| Attribute | Details |
|---|---|
| Runtime | Unique identifier for the log. |
| Identifier | |
| Sensor Identifier | Sensor's unique identifier. |
| Status | Status of the sensor run: |
| | Successful |
| | Error |
| | Warning |
| Start Time | Start time of the sensor run. |
| End Time | End time of the sensor run. |
| Total Records | The total number of records matching the conditions. |
| Parameter | Any parameter values. |
| Values | |
| Actions Fired | List of the action ids fired. |
| Priority | Priority at which the sensor executed. |
| Timeout Flag | Indicates whether the action was fired due to time out. |

Sensor Schedules. Sensor schedules may define the period and/or the frequency at which the schedule-type sensor conditions should be checked. Functional sensors can be triggered by CDC event or they can be scheduled to run periodically. A functional sensor could have multiple scheduled assigned. For example, an example customer stops the import process for new invoices (UK) 24-36 hours before the occasion of month end close. In this example, the focus is to process and close the related month end invoices first. For the example customer, during month end, intercompany invoices are validated, approved and paid/accounted immediately once they are imported successfully.

Customers can define a schedule with the interval type set to an alternate value, such as Day, Month, etc. which will act as guidance to the sensor process regarding when to evaluate the sensor.

Sensor schedules may be configured to support the ability to increment parameters (e.g., Accounting Period, Calculation Effective Date) automatically. Date Variables PERIOD_CLOSE_END & PERIOD_CLOSE_START can be used in the Start Time/End Time.

In one embodiment, a sensor schedule definition includes the attributes listed in Table 9:

TABLE 9

| Attribute | Details |
|---|---|
| Schedule | Unique identifier. |
| Identifier | |
| Profile | Foreign key to Sensor Profiles. |
| Identifier | |
| Frequency | The Frequency defines the unit of measure at which the |
| | schedule should repeat. Valid values are: |
| | Continuously |
| | Minute |
| | Hourly |
| | Daily |
| | Weekly |
| | Monthly |
| | Yearly |
| | Period |
| Accounting | Accounting Calendar to use when the Frequency is set to |
| Calendar | Period or PERIOD-CLOSE-END or PERIOD-CLOSE |
| | START is used in the Start/End Times. |
| Time | Time Between Runs is used when the Frequency is Minute, |
| Between | Hourly, Daily or Weekly. |
| Runs | For example, a Frequency = Hourly and Time Between |
| | Runs = 2 would indicate that the functional sensor's |
| | conditions should be evaluated every 2 Hours. |
| Repeat By | Used when Frequency is either Monthly or Yearly. Valid |
| | values are: |
| | Day |
| | Date |
| Months | Used when the Frequency is Yearly. List of Months when |
| | the Sensor should execute. |
| Weeks | Used when the Frequency is Monthly or Yearly. Specifies |
| | the weeks of the month that the Sensor should execute. |
| Days | Used when the Frequency is Weekly, Monthly or Yearly. |
| | Specifies the days of the week that the Sensor should |
| | execute. |
| Hours | Used when the Frequency is Daily, Weekly, Monthly or |
| | Yearly. Used to denote which hours the sensor should |
| | execute. |
| Dates | Used when the Frequency is Monthly or Yearly and the |
| | Repeat By is Dates. Specify the dates of the Month that the |
| | Sensor should execute. |
| Start Time | Schedule start date and time. |
| End Time | Schedule end date and time. The schedule will not repeat |
| | again after the end time. |
| Enabled | Enabled flag. |
| Seeded | Seeded flag. |

Examples of Sensor Schedules. Examples of sensor schedules are shown in the following Tables 10-13.

Example of Sensor Schedules-Date-Time Patterns. Table 10 shows a sensor schedule to run payables invoice import process at 8 am PST every day.

TABLE 10

| | |
|---|---|
| Frequency | Daily |
| Time Between | 1 |
| Runs | |
| Repeat By | N/A |
| Months | N/A |
| Weeks | N/A |
| Days | N/A |
| Hours | N/A |
| Dates | N/A |
| Start Time | 01-MAR-2023 8:00 |
| End Time | |

Table 11 shows a sensor schedule to run payables invoice validation hourly from 10 am to 1 pm every day.

TABLE 11

| | |
|---|---|
| Frequency | Daily |
| Time Between | 1 |
| Runs | |
| Repeat By | N/A |
| Months | N/A |
| Weeks | N/A |
| Days | N/A |
| Hours | 10, 11, 12, 13 |
| Dates | N/A |
| Start Time | 01-MAR-2023 10:00 |
| End Time | |

Example of Sensor Schedules-Financials/Subledger Patterns. Table 12 shows a sensor schedule to run the period close process group every day for 3 days before accounting period close date threshold is met.

TABLE 12

| | |
|---|---|
| Frequency | Period |
| Accounting | Monthly |
| Calendar | |
| Time Between | 1 |
| Runs | |
| Repeat By | N/A |
| Months | N/A |
| Weeks | N/A |
| Days | PERIOD-CLOSE-DATE-3, PERIOD-CLOSE-DATE-2, |
| | PERIOD-CLOSE-DATE-1 |
| Hours | N/A |
| Dates | N/A |
| Start Time | PERIOD-CLOSE-DATE-3 08:00 |
| End Time | PERIOD-CLOSE-DATE 08:00 |

Table 13 shows a sensor schedule to run the period close process group every 4 hours on final day of period close.

TABLE 13

| | |
|---|---|
| Frequency | Accounting Calendar |
| Accounting | Monthly |
| Calendar | |
| Time Between | 1 |
| Runs | |
| Repeat By | N/A |
| Months | N/A |
| Weeks | N/A |
| Days | N/A |
| Hours | 0, 4, 8, 12, 16, 20 |
| Dates | N/A |
| Start Time | PERIOD-CLOSE-DATE 00:00 |
| End Time | |

### —Discussion of ERP Sensor Signaling: Use Cases—

Example use cases for the functional sensor system includes Simplified Approvals, Collections KPI, and AR Invoice Approval.

Regarding Simplified Approvals, a problem today is that customers do not have an easy mechanism to introduce controls on their transactions lifecycle in ERP. It can take nine months for applications team to build an approval process and deliver to customer. Functional sensor could provide a simplified model where customer can enable/disable approvals on their objects lifecycle.

Anything sent for approval including an “auto-approval” is routed through BPM. BPM increases the complexity and has lot of performance inefficiencies, causing outages which breaks the customers flow. Functional sensors could detect auto-approval conditions bypassing BPM and thereby improving operational efficiency and minimizing customer outage.

In many cases, customers are configuring approvals purely as mechanism to receive notifications as opposed to any need for control. Again, functional sensors would provide an easy mechanism to turn on notification as opposed to configuring BPM.

### —Discussion of ERP Sensor Signaling: Further Features—

In one embodiment, the functional sensor system includes functionality to detect a data change event, evaluate a rule and call BOSS API or SOA Workflow. This enables: (1) Eliminating expense reimbursement ESS job; and (2) Lightweight auto-approval: detect when transactions have been validated, evaluate rules and if appropriate, call BOSS API to auto-approve or send to BPM for manual approval.

In one embodiment, the functional sensor system includes functionality to detect a data change event, evaluate a rule and initiate an approval workflow directly, processing any invoices that haven't been auto-approved by lightweight approvals. This enables eliminating invoice approval ESS job.

In one embodiment, the functional sensor system includes functionality to detect a data change event, evaluate a rule and initiate a BPO task. This enables: (1) Simplification of payables invoice import and validation jobs; and (2) Simplification of process expense reimbursement.

### —Discussion of ERP Sensor Signaling: Conceptual Diagram—

FIG. 11 illustrates one embodiment of a conceptual diagram 1100 for an functional sensor system that is associated with a framework to configure and generate operational data signals for controls. A legend 1105 of the crow's foot notation for interrelationships of the entities is provided.

Sensor: Sensor table 1110 shows a definition of the functional sensor along with the properties associated with the sensor-like category, business object, enabled vs. disabled, execution mode, etc. Ref.: Sensor Configuration-Sensor Definition.

Sensor Category: Sensor category table 1115 shows a definition of seeded implicit business condition and frequency of a given sensor.

Business Condition: As shown in business condition table 1120, a business condition includes a group of functional criteria that are shown in criteria table 1125.

Criteria: Criteria table 1125 provides a list of functional conditions that is used to filter the business object to apply an action.

Schedule: Schedule table 1130 indicates frequency of execution of a functional sensor that is either seeded or defined by customers.

Action: Action table 1135 indicates one or more actions associated with a business condition.

### —Discussion of ERP Sensor Signaling: Logical Data Model Diagram—

FIG. 9 illustrates one embodiment of a logical data model diagram 900 for an functional sensor system that is associated with a framework to configure and generate operational data signals for controls. Description of the entities in the logical model is provided in the Functional Sensor Tables below.

Sensors 1205. The sensors table shown in Table 14 stores the sensor definition.

TABLE 14

| Column Name | Description |
|---|---|
| SENSOR_ID | Unique identifier. |
| CATEGORY_ID | Foreign Key to Sensor Categories 1210. |
| OBJECT_ID | Foreign Key to Business Objects 1230. |
| IMPLICIT_{—} | Implicit Business Condition Id in Rule platform. |
| CONDITION_ID | |
| PRODUCT_ID | Product ID. |
| SENSOR_NAME | Sensor display name. |
| EXECUTION_{—} | Mode can be a Data Change or Scheduled. |
| MODE | |
| TRIGGER_{—} | If Execution Mode is Data Change, then specify |
| EVENT | which CRUD events trigger the sensor. |
| DESCRIPTION | Sensor description. |
| ENABLED | Enabled flag. |
| SEEDED | Seeded flag. |
| PRIORITY | The priority is used to schedule the sensor process |
| | processes. Sensors with a higher priority should run |
| | before those with a lower priority. The default value |
| | is −1. |

Sensor Categories 1210. The sensor categories table shown in Table defines sensor categories.

TABLE 15

| Column Name | Description |
|---|---|
| CATEGORY_ID | Unique identifier. |
| SENSOR_CATEGORY | Category Name |
| ENABLED | Enabled flag. |
| SEEDED | Seeded flag. |

Sensor Schedules 1215. The sensor schedules table shown in Table 16 stores the schedules governing when a schedule type sensor should run.

TABLE 16

| Column Name | Description |
|---|---|
| SCHEDULE_ID | Unique identifier. |
| SENSOR_ID | Foreign Key to Sensors 1205. |
| FREQUENCY | The Frequency defines the unit of measure at |
| | which the schedule should repeat. Valid values |
| | are: |
| | Continuously |
| | Minute |
| | Hourly |
| | Daily |
| | Weekly |
| | Monthly |
| | Yearly |
| | Period |
| ACCOUNTING_{—} | Accounting Calendar to use when the |
| CALENDAR | Frequency is set to Period or PERIOD-CLOSE- |
| | END or PERIOD-CLOSE_START is used in the |
| | Start/End Times. |
| TIME_{—} | Time Between Runs is used when the |
| BETWEEN_{—} | Frequency is Minute, Hourly, Daily or Weekly. |
| RUNS | For example, a Frequency = Hourly and Time |
| | Between Runs = 2 would indicate that the |
| | functional sensor's conditions should be |
| | evaluated every 2 Hours. |
| REPEAT_BY | Used when Frequency is either Monthly or |
| | Yearly. Valid values are: |
| | Day |
| | Date |
| MONTHS | Used when the Frequency is Yearly. List of |
| | Months when the Sensor should execute. |
| WEEKS | Used when the Frequency is Monthly or Yearly. |
| | Specifies the weeks of the month that the |
| | Sensor should execute. |
| DAYS | Used when the Frequency is Monthly or Yearly. |
| | Specifies the days of the week that the Sensor |
| | should execute. |
| DATES | Used when the Frequency is Monthly or Yearly |
| | and the Repeat By is Dates. Specify the dates |
| | of the Month that the Sensor should execute. |
| START_TIME | Schedule start time. |
| END_TIME | Schedule end time. The schedule will not repeat |
| | again after the end time. |
| ENABLED | Enabled flag. |
| SEEDED | Seeded flag. |

Actions 1220. The actions table shown in Table 17 stores action definitions. Contains a foreign key to Action Types which defines the types of actions such as Process, Email, Notification, API, etc.

TABLE 17

| Column Name | Description |
|---|---|
| ACTION_ID | Unique identifier. |
| BUSINESS_{—} | Foreign key to Business Conditions. |
| CONDITION_ID | |
| ACTION_TYPE | Action Type, e.g. BPO Process, EMAIL, etc. |
| DESCRIPTION | Description. |
| PARAMETERS | Parameters. |
| ENABLED | Enabled flag. |
| SEEDED | Seeded flag. |

Criteria 1225. Criteria 1225 represents the fine-grained conditions that help determine whether a business condition 1235 is fulfilled, such as with field- or attribute-level checks (e.g., “invoice amount >X”).

Business Objects 1230. Business objects 1230 store the definition and identity of entities in the enterprise data system (e.g., an Invoice object or Journal object). Individual sensors 1205 link to a business object via Object Id, indicating which domain entity that functional sensor is designed to observe or act upon.

Business Conditions 1235. The business conditions 1235 capture specific rules or criteria that a functional sensor evaluates when deciding whether to trigger an action. Each record in this table references a particular sensor 1205 and also an action 1220. The business conditions store attributes to define the logical thresholds or requirements that are to be satisfied for the action to occur. The actions table shown in Table 17 stores action definitions.

### —Discussion of ERP Sensor Signaling: Conceptual Diagram—

FIG. 13 illustrates one embodiment of a sensor entity diagram 1300 for an functional sensor system that is associated with a framework to configure and generate operational data signals for controls. Descriptions of various entities in an example functional sensor system follow.

Sensor 1310: Definition of the functional sensor along with the properties associated with the sensor-like category, business object, enabled vs. disabled, execution mode, etc. Ref.: Sensor Configuration-Sensor Definition.

Sensor Category 1315: Defines seeded implicit business condition and frequency of a given sensor.

Rules 1320: A rule can be defined as the set of functional conditions connected by operator (OR/AND).

Condition 1325: List of functional condition that is used to filter the business object to apply an action.

Schedule 1330: Frequency or execution of a functional sensor that's either seeded or defined by customers.

Action 1335: One or more actions associated with a rule.

Business Object 1340: Represent the root functional business object for which the sensor rules are defined. For example: Invoice, Journal Expenses, etc.

Schedule Monitor 1345: Stores the active sensor schedules to be executed base on the next_execution_time.

Sensor Instance 1350: Stores the high level sensor instance details of each sensor execution.

Sensor Instance Tasks 1355: Stores the sensor instance task details corresponding to each lifecycle task from associated sensor formula.

Fault 1360: Stores all the faults details associated with a sensor instance task or action failure.

Formula 1365: Abstraction of the execution algorithms of various sensor categories.

### —Cloud or Enterprise Embodiments—

In one embodiment, the present system (such as an functional sensor system) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, an functional sensor system is a centralized server-side application that provides at least the functions disclosed herein and that is accessed by many users by way of computing devices/terminals communicating with the computers of an functional sensor system (functioning as one or more servers) over a computer network. In one embodiment an functional sensor system may be implemented by a server or other computing device configured with hardware and software to implement the functions and features described herein.

In one embodiment, the components of an functional sensor system may be implemented as sets of one or more software modules executed by one or more computing devices specially configured for such execution. In one embodiment, the components of an functional sensor system are implemented on one or more hardware computing devices or hosts interconnected by a data network. For example, the components of an functional sensor system may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of an functional sensor system intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of an functional sensor system may (i) generate or compose an electronic message or signal to issue a command or request to another component, (ii) transmit the message or signal to other components of an functional sensor system, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by an functional sensor system, for example through a web interface server. In one embodiment, the remote computing system may send requests to and receive responses from an functional sensor system. In one example, access to the information or applications may be effected through use of a web browser on a personal computer or mobile device. In one example, communications exchanged with an functional sensor system may take the form of remote representational state transfer (REST) requests using JavaScript object notation (JSON) as the data interchange format for example, or simple object access protocol (SOAP) requests to and from XML servers. The REST or SOAP requests may include API calls to components of an functional sensor system.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### —Computing Device Embodiment—

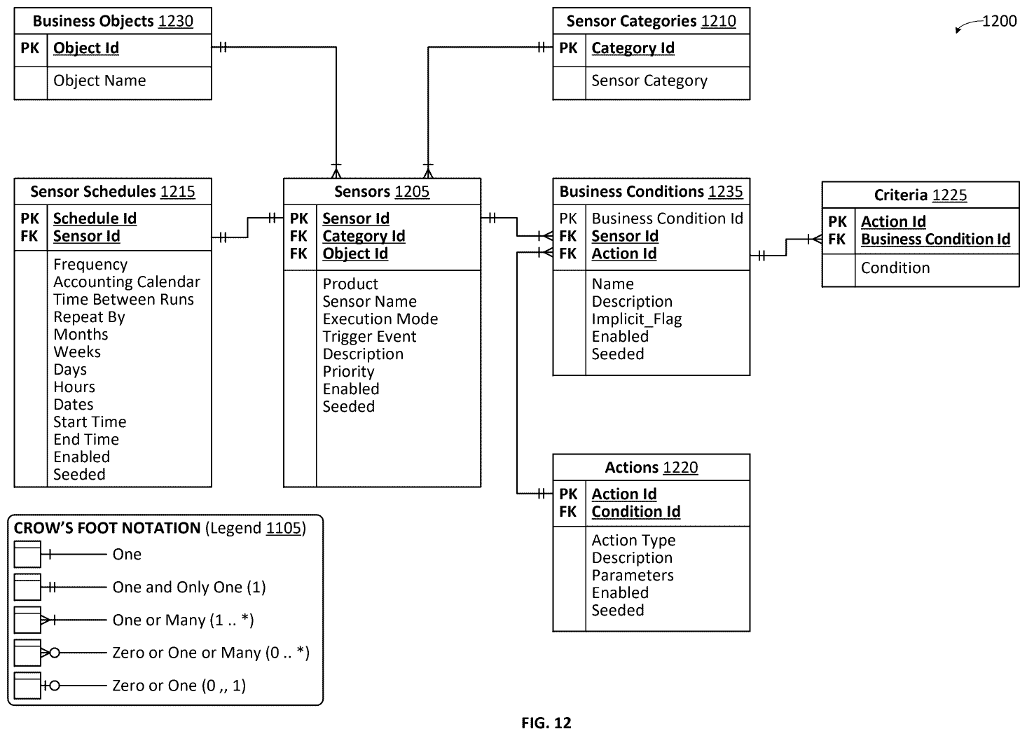

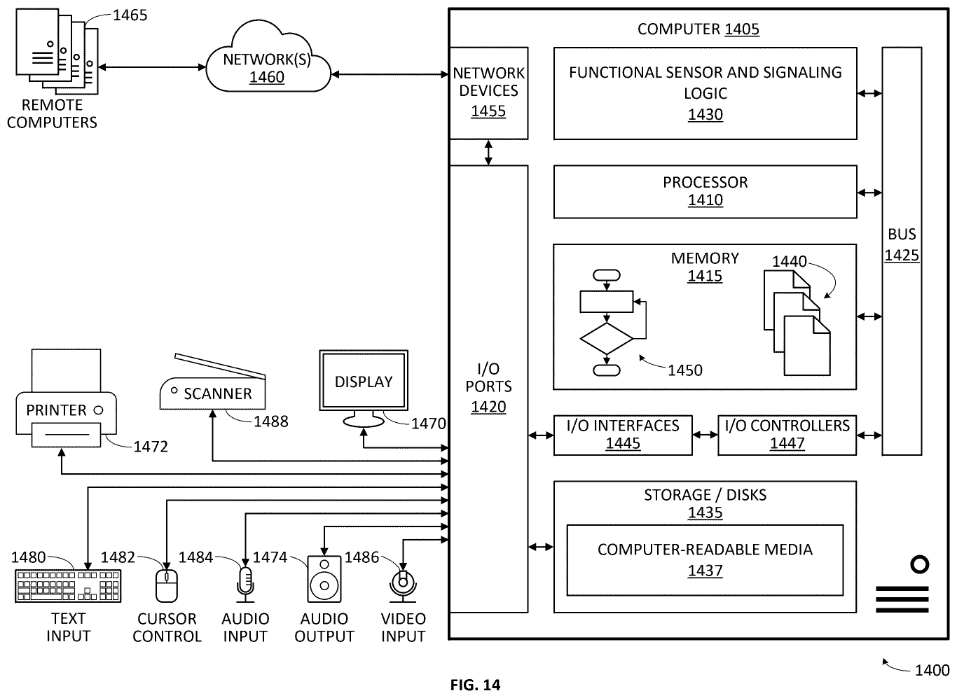

FIG. 14 illustrates an example computing system 1400 that is configured and/or programmed as a special purpose computing device(s) with one or more of the example systems and methods described herein, and/or equivalents. The example computing device may be a computer 1405 that includes at least one hardware processor 1410, a memory 1415, and input/output ports 1420 operably connected by a bus 1425. In one example, the computer 1405 may include Functional Sensor and Signaling Logic 1430 configured to facilitate configuration and generation of operational data signals for controls, similar to the logic, systems, methods, and other embodiments shown in and described with reference to FIGS. 1-13.

In different examples, the logic 1430 may be implemented in hardware, one or more non-transitory computer-readable media 1437 with stored instructions, firmware, and/or combinations thereof. While the logic 1430 is illustrated as a hardware component attached to the bus 1425, it is to be appreciated that in other embodiments, the logic 1430 could be implemented in the processor 1410, stored in memory 1415, or stored in disk 1435.

In one embodiment, logic 1430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate configuration and generation of operational data signals for controls. The means may also be implemented as stored computer executable instructions that are presented to computer 1405 as data 1440 that are temporarily stored in memory 1415 and then executed by processor 1410.

Logic 1430 may also provide means (e.g., hardware, non-transitory computer-readable medium that stores executable instructions, firmware) for performing one or more of the disclosed functions and/or combinations of the functions.

Generally describing an example configuration of the computer 1405, the processor 1410 may be a variety of various processors including dual microprocessor and other multi-processor architectures. A memory 1415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 1435 may be operably connected to the computer 1405 via, for example, an input/output (I/O) interface (e.g., card, device) 1445 and an input/output port 1420 that are controlled by at least an input/output (I/O) controller 1447. The disk 1435 may be, for example, a magnetic disk drive, a solid-state drive, a floppy disk drive, a tape drive, a Zip drive, a flash memory card, a memory stick, and so on. Furthermore, the disk 1435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 1415 can store a process 1450 and/or a data 1440, for example. The disk 1435 and/or the memory 1415 can store an operating system that controls and allocates resources of the computer 1405.

The computer 1405 may interact with, control, and/or be controlled by input/output (I/O) devices via the input/output (I/O) controller 1447, the I/O interfaces 1445, and the input/output ports 1420. Input/output devices may include, for example, one or more network devices 1455, displays 1470, printers 1472 (such as inkjet, laser, or 3D printers), audio output devices 1474 (such as speakers or headphones), text input devices 1480 (such as keyboards), cursor control devices 1482 for pointing and selection inputs (such as mice, trackballs, touch screens, joysticks, pointing sticks, electronic styluses, electronic pen tablets), audio input devices 1484 (such as microphones or external audio players), video input devices 1486 (such as video and still cameras, or external video players), image scanners 1488, video cards (not shown), disks 1435, and so on. The input/output ports 1420 may include, for example, serial ports, parallel ports, and USB ports.

The computer 1405 can operate in a network environment and thus may be connected to the network devices 1455 via the I/O interfaces 1445, and/or the I/O ports 1420. Through the network devices 1455, the computer 1405 may interact with a network 1460. Through the network 1460, the computer 1405 may be logically connected to remote computers 1465. Networks with which the computer 1405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
accept input that defines a configuration for a functional sensor in a metadata repository of an enterprise data system, wherein the configuration specifies one or more conditions applied to one or more data sources for triggering a signal associated with initiation of a task;
monitor the one or more data sources of the enterprise data system enterprise data system with the functional sensor for transaction changes that satisfy the one or more conditions for triggering the signal;
detect a transaction change that satisfies the one or more conditions with the functional sensor;
emit the signal in response to detection that the one or more conditions for triggering the signal are satisfied; and
in response to receiving the signal, automatically execute the task in the enterprise data system.

2. The non-transitory computer-readable media of claim 1, wherein the instructions when executed by at least the processor of the computing system further cause the computing system to register the configured functional sensor in a metadata repository of the enterprise data system to cause the enterprise data system to execute the functional sensor at runtime.

3. The non-transitory computer-readable media of claim 1, wherein the instructions when executed by at least the processor of the computing system further cause the computing system to define the functional sensor as belonging to one of:
(a) an approval category for which the signal from the functional sensor triggers approving a transaction as the task,
(b) a key performance indicator category for which the signal from the functional sensor triggers generating a data value for performance with respect to a goal as the task,
(c) a notification category for which the signal from the functional sensor triggers notifying a system or user of information as the task,
(d) a process automation category for which the signal from the functional sensor triggers initiating a process automation flow as the task,
(e) an enrichment category for which the signal from the functional sensor triggers data enrichment as the task,
(f) a holds category for which the signal from the functional sensor triggers placement or release of a hold as the task,
(g) an audit category for which the signal from the functional sensor triggers an audit process as the task, or
(h) an infrastructure category for which the signal from the functional sensor triggers infrastructure management as the task.

4. The non-transitory computer-readable media of claim 1, wherein the instructions when executed by at least the processor of the computing system further cause the computing system to:
accept a frequency in the input;
configure the functional sensor to repeatedly execute at runtime at the frequency; and
repeat the monitoring the one or more data sources, the detecting the transaction change, and the emitting the signal at the frequency.

5. The non-transitory computer-readable media of claim 1, wherein the instructions when executed by at least the processor of the computing system further cause the computing system to:
accept a relative time away from an occasion in the input;
determine an occasion time at which the occasion will occur;
determine a non-relative time based on the occasion time and the relative time; and
execute the functional sensor at the non-relative time.

6. The non-transitory computer-readable media of claim 1, wherein the instructions when executed by at least the processor of the computing system further cause the computing system to execute the functional sensor at runtime in response to receipt of the transaction change.

7. The non-transitory computer-readable media of claim 1, wherein the input that defines a configuration is provided in natural language, wherein the instructions when executed by at least the processor of the computing system further cause the computing system to convert the natural language to the one or more conditions.

8. A computing system, comprising:
at least one processor connected to at least one memory;
one or more non-transitory computer-readable media that include stored thereon computer-executable instructions that when executed by at least the processor of a computing system cause the computing system to:
accept input that defines a configuration for a functional sensor in a metadata repository of an enterprise data system, wherein the configuration specifies one or more conditions applied to one or more data sources for triggering a signal associated with initiation of a task;
monitor the one or more data sources of the enterprise data system with the functional sensor for transaction changes that satisfy the one or more conditions for triggering the signal;
detect a transaction change that satisfies the one or more conditions with the functional sensor;
emit the signal in response to detection that the one or more conditions for triggering the signal are satisfied; and
in response to receiving the signal, automatically execute the task in the enterprise data system.

9. The computing system of claim 8, wherein the instructions when executed by at least the processor of the computing system further cause the computing system to register the configured functional sensor in a metadata repository of the enterprise data system to cause the enterprise data system to execute the functional sensor at runtime.

10. The computing system of claim 8, wherein the instructions when executed by at least the processor of the computing system further cause the computing system to define the functional sensor as belonging to one of:
(a) an approval category for which the signal from the functional sensor triggers approving a transaction as the task,
(b) a key performance indicator category for which the signal from the functional sensor triggers generating a data value for performance with respect to a goal as the task,
(c) a notification category for which the signal from the functional sensor triggers notifying a system or user of information as the task,
(d) a process automation category for which the signal from the functional sensor triggers initiating a process automation flow as the task,
(e) an enrichment category for which the signal from the functional sensor triggers data enrichment as the task,
(f) a holds category for which the signal from the functional sensor triggers placement or release of a hold as the task,
(g) an audit category for which the signal from the functional sensor triggers an audit process as the task, or
(h) an infrastructure category for which the signal from the functional sensor triggers infrastructure management as the task.

11. The computing system of claim 8, wherein the instructions when executed by at least the processor of the computing system further cause the computing system to:
accept a frequency in the input;
configure the functional sensor to repeatedly execute at runtime at the frequency; and
repeat the monitoring the one or more data sources, the detecting the transaction change, and the emitting the signal at the frequency.

12. The computing system of claim 8, wherein the instructions when executed by at least the processor of the computing system further cause the computing system to:
accept a relative time away from an occasion in the input;
determine an occasion time at which the occasion will occur;
determine a non-relative time based on the occasion time and the relative time; and
execute the functional sensor at the non-relative time.

13. The computing system of claim 8, wherein the instructions when executed by at least the processor of the computing system further cause the computing system to execute the functional sensor at runtime in response to receipt of the transaction change.

14. The computing system of claim 8, wherein the input that defines a configuration is provided in natural language, wherein the instructions when executed by at least the processor of the computing system further cause the computing system to convert the natural language to the one or more conditions.

15. A computer-implemented method, comprising:
accepting input that defines a configuration for a functional sensor in a metadata repository of an enterprise data system, wherein the configuration specifies one or more conditions applied to one or more data sources for triggering a signal associated with initiation of a task;
monitoring the one or more data sources of the enterprise data system with the functional sensor for transaction changes that satisfy the one or more conditions for triggering the signal;
detecting a transaction change that satisfies the one or more conditions with the functional sensor;
emitting the signal in response to detection that the one or more conditions for triggering the signal are satisfied; and
in response to receiving the signal, automatically executing the task in the enterprise data system.

16. The computer-implemented method of claim 15, further comprising, after accepting the input, registering the configured functional sensor in a metadata repository of the enterprise data system to cause the enterprise data system to execute the functional sensor at runtime.

17. The computer-implemented method of claim 15, further comprising:
accepting a frequency in the input;
configuring the functional sensor to repeatedly execute at runtime at the frequency; and
repeating the steps of monitoring the one or more data sources, detecting the transaction change, and emitting the signal at the frequency.

18. The computer-implemented method of claim 15, further comprising:
accepting a relative time away from an occasion in the input;
determining an occasion time at which the occasion will occur;
determining a non-relative time based on the occasion time and the relative time; and
executing the functional sensor at the non-relative time.

19. The computer-implemented method of claim 15, further comprising executing the functional sensor at runtime in response to receipt of the transaction change.

20. The computer-implemented method of claim 15, wherein the input that defines a configuration is provided in natural language, the method further comprising converting the natural language to the one or more conditions.
